(19) United States
(12) Patent Application Publication
(10) Pub. No.: US 2026/0080190 A1
(43) Pub. Date: Mar. 19, 2026

(54) DATA PROCESSING METHOD AND RELATED DEVICE

(71) Applicant: HUAWEI TECHNOLOGIES CO., LTD., Shenzhen (CN)

(72) Inventors: Renlong Jie, Shenzhen (CN); Xiaojun Meng, Shenzhen (CN); Lifeng Shang, Shenzhen (CN); Xin Jiang, Hong Kong (CN); Qun Liu, Hong Kong (CN)

(73) Assignee: HUAWEI TECHNOLOGIES CO., LTD., Shenzhen (CN)

(21) Appl. No.: 19/402,091

(22) Filed: Nov. 26, 2025

Related U.S. Application Data
(63) Continuation of application No. PCT/CN2024/096349, filed on May 30, 2024.

(30) Foreign Application Priority Data
Jun. 1, 2023 (CN) 202310646933.7

(51) Int. Cl. G06F 40/40; G06F 40/284

(52) U.S. Cl. CPC G06F 40/40; G06F 40/284

(57) ABSTRACT

A data processing method is provided, and relates to the field of artificial intelligence. The method includes: obtaining a first feature representation and a second feature representation, where the first feature representation is obtained by performing feature extraction on a first text, the second feature representation is obtained by performing feature extraction on a prompt, and the prompt indicates to perform compression at a target compression ratio; compressing the first feature representation and the second feature representation at the target compression ratio, to obtain compressed feature representations; and obtaining, based on the compressed feature representations, a second text by using a large language model, where the second text is used as a reply text to the first text.

### CROSS-REFERENCE TO RELATED APPLICATIONS

This application is a continuation of International Application No. PCT/CN2024/096349, filed on May 30, 2024, which claims priority to Chinese Patent Application No. 202310646933.7, filed on Jun. 1, 2023. The disclosures of the aforementioned applications are hereby incorporated by reference in their entireties.

### TECHNICAL FIELD

This application relates to the field of artificial intelligence, and in particular, to a data processing method and a related device.

### BACKGROUND

Artificial intelligence (AI) is a theory, a method, a technology, and an application system in which human intelligence is simulated and extended by using a digital computer or a machine controlled by a digital computer, to perceive an environment, obtain knowledge, and achieve an optimal result by using the knowledge. In other words, artificial intelligence is a branch of computer science, and attempts to understand essence of intelligence and produce a new intelligent machine that can react in a manner similar to human intelligence. Artificial intelligence is to research design principles and implementation methods of various intelligent machines, so that the machines have perception, inference, and decision-making functions.

Since the release of ChatGPT, capabilities and future potential of large foundation models (for example, large language models (LLMs)) have received widespread attention from all walks of life. Large models can usually process a limited input length. For example, ChatGPT can process a maximum length of 4096 tokens, while GPT-4 can process a maximum length of 30000 tokens. However, in reality, there is a large amount of long-sequence information, such as papers, books, multiple documents, long conference information, and long code information. In addition, when the large models engage in conversations with users, processing of long conversation historical information is also involved.

Therefore, there is an urgent need for a method that can improve a long-sequence processing capability of the large models.

### SUMMARY

This application provides a data processing method, which can improve a long-sequence processing capability of a large model.

According to a first aspect, this application provides a data processing method. The method includes: obtaining a first feature representation and a second feature representation, where the first feature representation is obtained by performing feature extraction on a first text, the second feature representation is obtained by performing feature extraction on a prompt, and the prompt indicates to perform compression at a target compression ratio; compressing the first feature representation and the second feature representation at the target compression ratio, to obtain compressed feature representations; and obtaining, based on the compressed feature representations, a second text by using a large language model, where the second text is used as a reply text to the first text.

First, the compression ratio carried in the prompt can provide the large model with a priori knowledge of compression information, so that the large model can generate a more accurate reply text when there is an input loss.

Second, the solution enables a large language model that has a set maximum length and has completed pre-training to adapt to continued pre-training, fine-tuning, and inference of a longer input sequence, without requiring retraining.

Third, a text input can be extended to an infinite length in theory, and dynamic-length text compression is also supported, to adapt to user inputs with different lengths.

Fourth, an arbitrary length input may be mapped to a fixed length, and a theoretical inference latency may be controlled at a complexity of O(1). Therefore, training and inference time and memory consumption for long sequences can be effectively controlled.

In an embodiment, the large language model is used to execute a target task, and the target task is one of the following: reading comprehension, text translation, paraphrase identification, named entity recognition, text sentiment analysis, natural language inference, text automatic question answering, text intent recognition, text classification, text simplification, and text story generation.

In an embodiment, a compression manner of the compression includes: an average pooling operation, or compression based on a text encoder.

One reason for defining the compression ratio in the prompt is that the compressed feature representation has a degree of information loss in terms of size and content compared to an uncompressed input. Therefore, the compression ratio carried in the prompt can provide the large model with a priori knowledge of compression information, so that the large model can generate a more accurate reply text when there is an input loss. In addition, when the compression manner is compression performed by using a neural network (which may be referred to as a compression model for short), the compression ratio carried in the prompt can also provide the compression model with a priori knowledge of compression information, so that the compression model enables the compressed feature representation to retain more valid information.

In an embodiment, the prompt further indicates the compression manner of the compression.

The compression manner may be average pooling, or compression based on a neural network.

Similarly, the compression manner of the compression is carried in the prompt to provide the large model with richer a priori knowledge of compression information, so that the large model can generate a more accurate reply text when there is an input loss.

In an embodiment, compressing the first feature representation and the second feature representation at the target compression ratio includes: splitting the first feature representation and the second feature representation, to obtain a plurality of sub-feature representations; and compressing each of the plurality of sub-feature representations at the target compression ratio.

In an embodiment, the method further includes: determining the target compression ratio based on a relationship between a length of the first text and a maximum input text length supported by the large language model.

In an embodiment, the compression manner of the compression is the compression based on the text encoder; and compressing the first feature representation and the second feature representation at the target compression ratio includes: encoding the first feature representation and the second feature representation by using the text encoder, to obtain encoding results; and using some of the encoding results as the compressed feature representations, where the some encoding results are a proportion, equal to the target compression ratio, of encoding results extracted from the encoding results.

In an embodiment, obtaining, based on the compressed feature representations, the second text by using the large language model includes: obtaining, based on the compressed feature representations and the second feature representation, the second text by using the large language model.

In an embodiment, obtaining, based on the compressed feature representations, the second text by using the large language model includes: obtaining, based on the compressed feature representations and by using the large language model, a feature representation output by a hidden layer of the large language model; and obtaining, based on the feature representation output by the hidden layer, the second text by using a text decoder.

According to a second aspect, this application provides a data processing method. The method includes:
obtaining a first feature representation and a second feature representation, where the first feature representation is obtained by performing feature extraction on a first text, the second feature representation is obtained by performing feature extraction on a prompt, and the prompt indicates to perform compression at a target compression ratio;
compressing the first feature representation and the second feature representation at the target compression ratio, to obtain compressed feature representations;
obtaining, based on the compressed feature representations, a second text by using a large language model; and
updating the large language model based on the second text and a corresponding ground truth value.

In an embodiment, the large language model is used to execute a target task, and the target task is one of the following:
reading comprehension, text translation, paraphrase identification, named entity recognition, text sentiment analysis, natural language inference, text automatic question answering, text intent recognition, text classification, text simplification, and text story generation.

In an embodiment, a compression manner of the compression includes:
an average pooling operation, or compression based on a text encoder.

In an embodiment, the prompt further indicates the compression manner of the compression.

In an embodiment, compressing the first feature representation and the second feature representation at the target compression ratio includes:
splitting the first feature representation and the second feature representation, to obtain a plurality of sub-feature representations; and
compressing each of the plurality of sub-feature representations at the target compression ratio.

In an embodiment, the compression manner of the compression is the compression based on the text encoder; and the method includes:
obtaining, based on the compressed feature representations, a predicted value of the first text and the prompt by using a text decoder; and
updating the text encoder based on the first text, the prompt, and the predicted value.

In an embodiment, the method further includes:
determining the target compression ratio based on a relationship between a length of the first text and a maximum input text length supported by the large language model.

In an embodiment, the compression manner of the compression is the compression based on the text encoder; and
compressing the first feature representation and the second feature representation at the target compression ratio includes:
encoding the first feature representation and the second feature representation by using the text encoder, to obtain encoding results; and
using some of the encoding results as the compressed feature representations, where the some encoding results are a proportion, equal to the target compression ratio, of encoding results extracted from the encoding results.

In an embodiment, obtaining, based on the compressed feature representations, the second text by using the large language model includes:
obtaining, based on the compressed feature representations and the second feature representation, the second text by using the large language model.

In an embodiment, obtaining, based on the compressed feature representations, the second text by using the large language model includes:
obtaining, based on the compressed feature representations and by using the large language model, a feature representation output by a hidden layer of the large language model; and
obtaining, based on the feature representation output by the hidden layer, the second text by using the text decoder.

According to a third aspect, this application provides a data processing apparatus. The apparatus includes:
an obtaining module, configured to obtain a first feature representation and a second feature representation, where the first feature representation is obtained by performing feature extraction on a first text, the second feature representation is obtained by performing feature extraction on a prompt, and the prompt indicates to perform compression at a target compression ratio; and
a processing module, configured to: compress the first feature representation and the second feature representation at the target compression ratio, to obtain compressed feature representations; and
obtain, based on the compressed feature representations, a second text by using a large language model, where the second text is used as a reply text to the first text.

In an embodiment, a compression manner of the compression includes:
an average pooling operation, or compression based on a text encoder.

In an embodiment, the prompt further indicates the compression manner of the compression.

In an embodiment, the processing module is configured to:
split the first feature representation and the second feature representation, to obtain a plurality of sub-feature representations; and
compress each of the plurality of sub-feature representations at the target compression ratio.

In an embodiment, the processing module is further configured to:
determine the target compression ratio based on a relationship between a length of the first text and a maximum input text length supported by the large language model.

In an embodiment, the compression manner of the compression is the compression based on the text encoder.

The processing module is configured to:
encode the first feature representation and the second feature representation by using the text encoder, to obtain encoding results; and
use some of the encoding results as the compressed feature representations. The some encoding results are a proportion, equal to the target compression ratio, of encoding results extracted from the encoding results.

In an embodiment, the processing module is configured to:
obtain, based on the compressed feature representations and the second feature representation, the second text by using the large language model.

According to a fourth aspect, this application provides a data processing apparatus. The apparatus includes:
an obtaining module, configured to obtain a first feature representation and a second feature representation, where the first feature representation is obtained by performing feature extraction on a first text, the second feature representation is obtained by performing feature extraction on a prompt, and the prompt indicates to perform compression at a target compression ratio; and
a processing module, configured to: compress the first feature representation and the second feature representation at the target compression ratio, to obtain compressed feature representations;
obtain, based on the compressed feature representations, a second text by using a large language model; and
update the large language model based on the second text and a corresponding ground truth value.

In an embodiment, the large language model is used to execute a target task, and the target task is one of the following:
reading comprehension, text translation, paraphrase identification, named entity recognition, text sentiment analysis, natural language inference, text automatic question answering, text intent recognition, text classification, text simplification, and text story generation.

In an embodiment, a compression manner of the compression includes:
an average pooling operation, or compression based on a text encoder.

In an embodiment, the prompt further indicates the compression manner of the compression.

In an embodiment, the processing module is configured to:
split the first feature representation and the second feature representation, to obtain a plurality of sub-feature representations; and
compress each of the plurality of sub-feature representations at the target compression ratio.

In an embodiment, the compression manner of the compression is the compression based on the text encoder; and the processing module is further configured to:
obtain, based on the compressed feature representations, a predicted value of the first text and the prompt by using a text decoder; and
update the text encoder based on the first text, the prompt, and the predicted value.

In an embodiment, the processing module is further configured to:
determine the target compression ratio based on a relationship between a length of the first text and a maximum input text length supported by the large language model.

In an embodiment, the compression manner of the compression is the compression based on the text encoder.

The processing module is configured to:
encode the first feature representation and the second feature representation by using the text encoder, to obtain encoding results; and
use some of the encoding results as the compressed feature representations. The some encoding results are a proportion, equal to the target compression ratio, of encoding results extracted from the encoding results.

In an embodiment, the processing module is configured to:
obtain, based on the compressed feature representations and the second feature representation, the second text by using the large language model.

In an embodiment, the processing module is configured to:
obtain, based on the compressed feature representations and by using the large language model, a feature representation output by a hidden layer of the large language model; and obtain, based on the feature representation output by the hidden layer, the second text by using the text decoder.

According to a fifth aspect, an embodiment of this application provides an execution device that may include a memory, a processor, and a bus system. The memory is configured to store a program. The processor is configured to execute the program in the memory, to perform the method according to any one of the first aspect and an embodiment of the first aspect.

According to a sixth aspect, an embodiment of this application provides a training device that may include a memory, a processor, and a bus system. The memory is configured to store a program. The processor is configured to execute the program in the memory, to perform the method in any one of the second aspect and an embodiment of the second aspect.

According to a seventh aspect, an embodiment of this application provides a computer-readable storage medium. The computer-readable storage medium stores a computer program. When the computer program is run on a computer, the computer is enabled to perform the method according to any one of the first aspect and an embodiment of the first aspect, or the method according to any one of the second aspect and an embodiment of the second aspect.

According to an eighth aspect, an embodiment of this application provides a computer program. When the computer program is run on a computer, the computer is enabled to perform the method according to any one of the first aspect and an embodiment of the first aspect, or the method according to any one of the second aspect and an embodiment of the second aspect.

According to a ninth aspect, this application provides a chip system. The chip system includes a processor, configured to support an execution device or a training device in implementing the functions in the foregoing aspects, for example, sending or processing data or information in the foregoing methods. In an embodiment, the chip system further includes a memory. The memory is configured to store program instructions and data that are necessary for the execution device or the training device. The chip system may include a chip, or may include a chip and another discrete component.

### BRIEF DESCRIPTION OF DRAWINGS

FIG. 1A is a diagram of a structure of an artificial intelligence main framework;

FIG. 1B is a diagram of a functional architecture of a natural language synthesis application according to an embodiment of this application;

FIG. 1C is a diagram of a physical architecture for running a natural language synthesis application according to an embodiment of this application;

FIG. 1D is a diagram of an optional hardware structure of a terminal 100;

FIG. 2 shows a natural language processing system;

FIG. 3 shows another natural language processing system;

FIG. 4 is a diagram of a device related to natural language processing according to an embodiment of this application;

FIG. 5 is a diagram of an embodiment of a data processing method according to an embodiment of this application;

FIG. 6 is a diagram of an embodiment of a data processing method according to an embodiment of this application;

FIG. 7 is a diagram of an embodiment of a data processing method according to an embodiment of this application;

FIG. 8 is a diagram of an embodiment of a data processing method according to an embodiment of this application;

FIG. 9A is a diagram of an embodiment of a data processing method according to an embodiment of this application;

FIG. 9B is a diagram of an embodiment of a data processing method according to an embodiment of this application;

FIG. 9C is a diagram of an embodiment of a data processing method according to an embodiment of this application;

FIG. 9D is a diagram of an embodiment of a data processing method according to an embodiment of this application;

FIG. 9E is a diagram of an embodiment of a data processing method according to an embodiment of this application;

FIG. 9F is a diagram of an embodiment of a data processing method according to an embodiment of this application;

FIG. 10 is a diagram of a structure of a data processing device according to an embodiment of this application;

FIG. 11 is a diagram of a structure of an execution device according to an embodiment of this application;

FIG. 12 is a diagram of a structure of a training device according to an embodiment of this application; and

FIG. 13 is a diagram of a structure of a chip according to an embodiment of this application.

### DESCRIPTION OF EMBODIMENTS

The following describes embodiments of the present disclosure with reference to the accompanying drawings in embodiments of the present disclosure. Terms used in embodiments of the present disclosure are merely intended to explain embodiments of the present disclosure, and are not intended to limit the present disclosure.

The following describes embodiments of this application with reference to the accompanying drawings. One of ordinary skilled in the art may learn that, with development of technologies and emergence of new scenarios, the technical solutions provided in embodiments of this application are also applicable to a similar technical problem.

In this specification, claims, and the accompanying drawings of this application, the terms “first”, “second”, and the like are intended to distinguish between similar objects but do not necessarily indicate an order or sequence. It should be understood that the terms used in such a way are interchangeable in proper circumstances, which is merely a discrimination manner that is used when objects having a same attribute are described in embodiments of this application. In addition, the terms “include”, “have” and any other variants mean to cover a non-exclusive inclusion, so that a process, method, system, product, or device that includes a series of units is not necessarily limited to those units, but may include other units not expressly listed or inherent to such a process, method, system, product, or device.

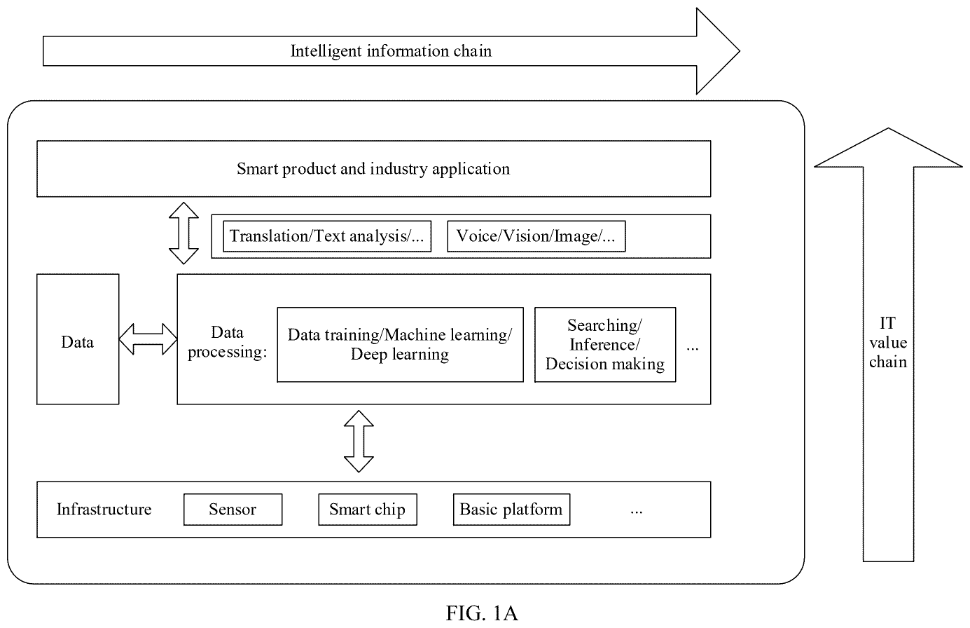

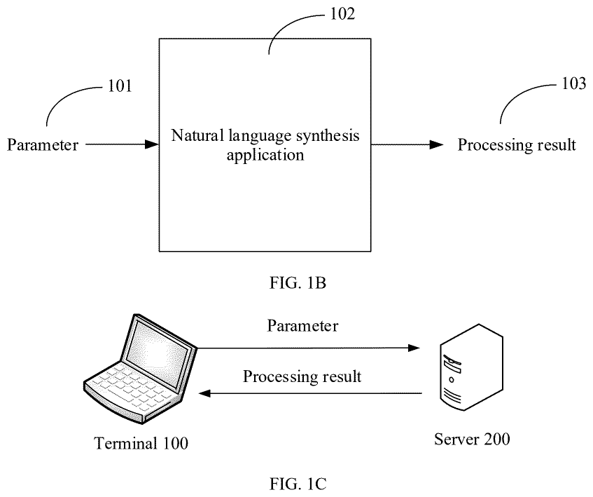

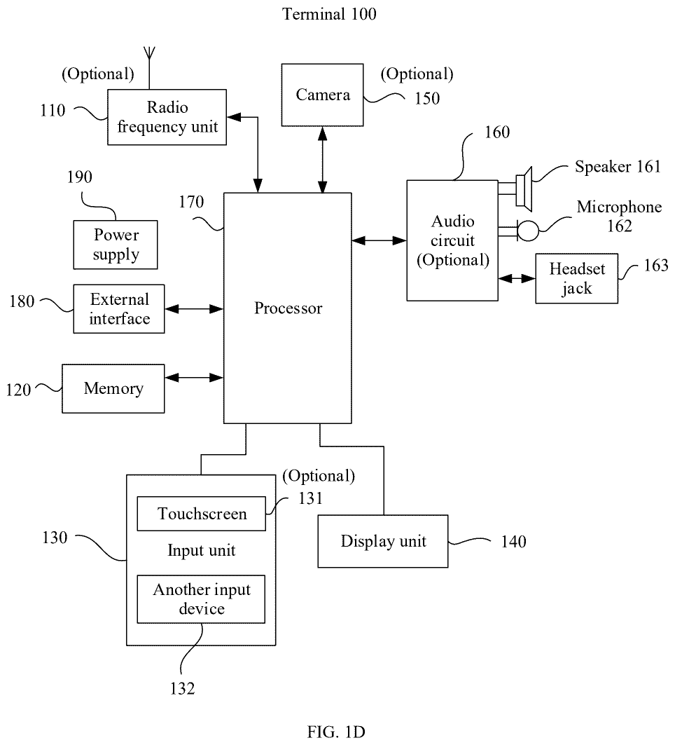

An overall working procedure of an artificial intelligence system is first described. FIG. 1A is a diagram of a structure of an artificial intelligence main framework. The following describes the artificial intelligence main framework from two dimensions: an “intelligent information chain” (a horizontal axis) and an “IT value chain” (a vertical axis). The “intelligent information chain” reflects a series of processes from obtaining data to processing the data. For example, the process may be a general process of intelligent information perception, intelligent information representation and formation, intelligent inference, intelligent decision-making, and intelligent execution and output. In this process, the data undergoes a refinement process of “data-information-knowledge-intelligence”. The “IT value chain” reflects a value brought by artificial intelligence to the information technology industry from an underlying infrastructure and information (technology providing and processing implementation) of artificial intelligence to an industrial ecological process of a system.

### (1) Infrastructure

The infrastructure provides computing capability support for the artificial intelligence system, implements communication with the external world, and implements support by using a basic platform. The infrastructure communicates with the outside through a sensor. A computing capability is provided by a smart chip (a hardware acceleration chip, for example, a CPU, an NPU, a GPU, an ASIC, or an FPGA). The basic platform includes related platform assurance and support such as a distributed computing framework and a network, and may include cloud storage and computing, an interconnected network, and the like. For example, the sensor communicates with the outside to obtain data, and the data is provided to a smart chip in a distributed computing system provided by the basic platform for computing.

### (2) Data

Data at an upper layer of the infrastructure indicates a data source in the field of artificial intelligence. The data relates to a graph, an image, a speech, and a text, further relates to Internet of things data of a conventional device, and includes service data of an existing system and perception data such as force, displacement, a liquid level, a temperature, and humidity.

### (3) Data Processing

Data processing usually includes data training, machine learning, deep learning, searching, inference, decision making, and the like.

Machine learning and deep learning may mean performing symbolic and formalized intelligent information modeling, extraction, preprocessing, training, and the like on data.

Inference is a process in which human intelligent inference is simulated in a computer or an intelligent system, and machine thinking and problem resolving are performed by using formalized information according to an inference control policy. A typical function is searching and matching.

Decision making is a process of making a decision after intelligent information is inferred, and usually provides functions such as classification, ranking, and prediction.

### (4) General Capability

After data processing mentioned above is performed on the data, some general capabilities may be further formed based on a data processing result. For example, the general capabilities may be an algorithm or a general system, for example, translation, text analysis, computer vision processing, speech recognition, and image recognition.

### (5) Smart Product and Industry Application

The smart product and industry application are products and applications of the artificial intelligence system in various fields. The smart product and industry application involve packaging overall artificial intelligence solutions, to productize and apply intelligent information decision-making. Application fields of the intelligent information decision-making mainly include a smart terminal, smart transportation, smart health care, autonomous driving, a smart city, and the like.

This application may be applied to the natural language processing field in the artificial intelligence field. The following uses natural language processing as an example to describe a plurality of application scenarios implemented in products.

Application scenarios of this application are first described. This application may be but is not limited to being applied to an application (which may be referred to as a natural language synthesis application below) having a natural language synthesis function, a cloud service provided by a cloud-side server, or the like. The following separately describes the application scenarios.

### 1. Natural Language Synthesis Application

A product form in embodiments of this application may be a natural language synthesis application. The natural language synthesis application may run on a terminal device or a cloud-side server.

Natural language generation may also be referred to as a text prediction task or a natural language synthesis task, which is a task of generating a missing text or a follow-up text for a given segment of text.

This application may be applied to natural language synthesis in a long-sequence scenario. The long-sequence scenario may be understood as a scenario in which a length of a text input to a model (or output by the model) is very long. For example, a long-sequence scenario includes long-text summarization, long-text question answering, multi-document summarization and question answering, meeting summarization and question answering, a multi-turn conversation, multi-turn educational question answering, multi-turn code generation, video summarization, mathematical proof verification and error correction, and the like. Inputs of the model may involve ultra-long sequences such as books, long papers, long videos, automatic speech recognition from meetings, multiple code files, multiple documents, high-resolution images, and extended mathematical proofs.

In an embodiment, a user may open the natural language synthesis application installed on the terminal device, and input text data (a text may be triggered by using an instruction, and may not be actively input by the user). The natural language synthesis application may process the text by using a model obtained through training according to a method provided in embodiments of this application, or process the text according to a method provided in embodiments of this application, and present a processing result to the user (a presentation manner may be but is not limited to displaying, playing, saving, or uploading to a cloud side).

In an embodiment, the user may open the natural language synthesis application installed on the terminal device, and input text data. The natural language synthesis application may send the text data to the cloud-side server. The cloud-side server processes the text by using a model obtained through training according to a method provided in embodiments of this application, and returns a processing result to the terminal device. The terminal device may present the processing result to the user (a presentation manner may be but is not limited to displaying, playing, saving, or uploading to a cloud side).

The following describes the natural language synthesis application in embodiments of this application separately from perspectives of a functional architecture and a product architecture for implementing a function.

FIG. 1B is a diagram of a functional architecture of the natural language synthesis application according to an embodiment of this application.

In an embodiment, as shown in FIG. 1B, the natural language synthesis application 102 may receive an input parameter 101 (for example, including a text) and generate a processing result 103. The natural language synthesis application 102 may be executed on (for example) at least one computer system, and include computer code. When the computer code is executed by one or more computers, the computer is enabled to execute a model obtained through training according to the method provided in embodiments of this application.

FIG. 1C is a diagram of a physical architecture for running the natural language synthesis application according to an embodiment of this application.

FIG. 1C is a diagram of a system architecture. The system may include a terminal 100 and a server 200. The server 200 may include one or more servers (in FIG. 1C, an example in which one server is included is used for description), and the server 200 may provide a natural language synthesis function for one or more terminals.

A natural language synthesis application may be installed on the terminal 100, or a web page related to the natural language synthesis function may be opened. The application and the web page may provide an interface. The terminal 100 may receive a related parameter input by a user on the interface of the natural language synthesis function, and send the parameter to the server 200. The server 200 may obtain a processing result based on the received parameter, and return the processing result to the terminal 100.

It should be understood that, in an embodiment, the terminal 100 may alternatively autonomously complete an action of obtaining the processing result based on the received parameter without a need to cooperate with the server. This is not limited in embodiments of this application.

The following describes a product form of the terminal 100 in FIG. 1C.

The terminal 100 in embodiments of this application may be a mobile phone, a tablet computer, a wearable device, a vehicle-mounted device, an augmented reality (AR)/virtual reality (VR) device, a notebook computer, an ultra-mobile personal computer (UMPC), a netbook, a personal digital assistant (PDA), or the like. This is not limited in embodiments of this application.

FIG. 1D is a diagram of an optional hardware structure of the terminal 100.

With reference to FIG. 1D, the terminal 100 may include components such as a radio frequency unit 110, a memory 120, an input unit 130, a display unit 140, a camera 150 (optional), an audio circuit 160 (optional), a speaker 161 (optional), a microphone 162 (optional), a processor 170, an external interface 180, and a power supply 190. One or ordinary skilled in the art may understand that FIG. 1D is merely an example of the terminal or a multi-functional device and does not constitute a limitation on the terminal or the multi-functional device. The terminal or the multi-functional device may include more or fewer components than those shown in the figure, or combine some components, or have different components.

The input unit 130 may be configured to: receive input digital or character information, and generate a key signal input related to user settings and function control of a portable multi-functional apparatus. In an embodiment, the input unit 130 may include a touchscreen 131 (optional) and/or another input device 132. The touchscreen 131 may collect a touch operation performed by a user on or near the touchscreen 131 (for example, an operation performed by the user on or near the touchscreen by using any proper object such as a finger, a joint, or a stylus), and drive a corresponding connection apparatus based on a preset program. The touchscreen may detect a touch action performed by the user on the touchscreen, convert the touch action into a touch signal, and send the touch signal to the processor 170, and can receive and execute a command sent by the processor 170. The touch signal includes at least touch point coordinate information. The touchscreen 131 may provide an input interface and an output interface between the terminal 100 and the user. In addition, the touchscreen may be implemented in a plurality of types, such as a resistive type, a capacitive type, an infrared ray type, and a surface acoustic wave type. In addition to the touchscreen 131, the input unit 130 may include the another input device. In an embodiment, the another input device 132 may include but is not limited to one or more of a physical keyboard, a functional button (for example, a volume control button or an on/off button), a trackball, a mouse, a joystick, and the like.

The another input device 132 may receive input image data or text data.

The display unit 140 may be configured to display information input by the user, information provided for the user, various menus of the terminal 100, an interaction interface, file display, and/or playing of any multimedia file. In embodiments of this application, the display unit 140 may be configured to display an interface of a natural language synthesis application, a processing result, and the like.

The memory 120 may be configured to store instructions and data. The memory 120 may mainly include an instruction storage area and a data storage area. The data storage area may store various kinds of data such as a multimedia file and a text; and the instruction storage area may store software units such as an operating system, an application, and instructions required by at least one function, or subsets and extended sets thereof. The memory 120 may further include a non-volatile random access memory, and provide hardware, software, a data resource, and the like in a management and calculation processing device to the processor 170, to support control on software and an application. The memory 120 is further configured to: store a multimedia file, and run a program and store an application.

The processor 170 is a control center of the terminal 100, connects parts of the entire terminal 100 by using various interfaces and lines, and executes various functions of the terminal 100 and processes data by running or executing the instructions stored in the memory 120 and invoking the data stored in the memory 120, to entirely control the terminal device. In an embodiment, the processor 170 may include one or more processing units. Preferably, an application processor and a modem processor may be integrated into the processor 170. The application processor mainly processes an operating system, a user interface, an application, and the like. The modem processor mainly processes wireless communication. It may be understood that the modem processor may not be integrated into the processor 170. In some embodiments, the processor and the memory may be implemented on a single chip. In other embodiments, the processor and the memory may be implemented on separate chips. The processor 170 may be further configured to: generate a corresponding operation control signal, send the operation control signal to a corresponding component in the calculation processing device, and read and process data in software, especially read and process the data and the program in the memory 120, so that each functional module performs corresponding functions, to control the corresponding component to perform an action as required by an instruction.

The memory 120 may be configured to store software code related to the data processing method. The processor 170 may perform operations of the data processing method of the chip, or may schedule other units (for example, the input unit 130 and the display unit 140) to implement corresponding functions.

The radio frequency unit 110 (optional) may be configured to receive and send information or receive and send signals during a call. For example, after receiving downlink information of a base station, the radio frequency unit 110 sends the downlink information to the processor 170 for processing. In addition, the radio frequency unit 110 sends uplink-related data to the base station. Usually, an RF circuit includes but is not limited to an antenna, at least one amplifier, a transceiver, a coupler, a low noise amplifier (LNA), a duplexer, and the like. In addition, the radio frequency unit 110 may further communicate with a network device and another device through wireless communication. The wireless communication may use any communication standard or protocol, including but not limited to a global system for mobile communications (GSM), a general packet radio service (GPRS), code division multiple access (CDMA), wideband code division multiple access (WCDMA), long term evolution (LTE), an email, a short message service (SMS), and the like.

In embodiments of this application, the radio frequency unit 110 may send image data or text data to the server 200, and receive a processing result sent by the server 200.

It should be understood that the radio frequency unit 110 is optional, and may be replaced with another communication interface, for example, may be a network interface.

The terminal 100 further includes the power supply 190 (for example, a battery) for supplying power to various components. Preferably, the power supply may be logically connected to the processor 170 by using a power management system, so that functions such as charging and discharging management and power consumption management are implemented by using the power management system.

The terminal 100 further includes the external interface 180. The external interface may be a standard micro USB interface, or may be a multi-pin connector, and may be configured to connect the terminal 100 to another apparatus for communication, or may be configured to connect to a charger to charge the terminal 100.

Although not shown, the terminal 100 may further include a flash, a wireless fidelity (Wi-Fi) module, a Bluetooth module, sensors with different functions, and the like. Details are not described herein. Some or all of the methods described below may be applied to the terminal 100 shown in FIG. 1D.

The following describes a product form of the server 200 in FIG. 1C.

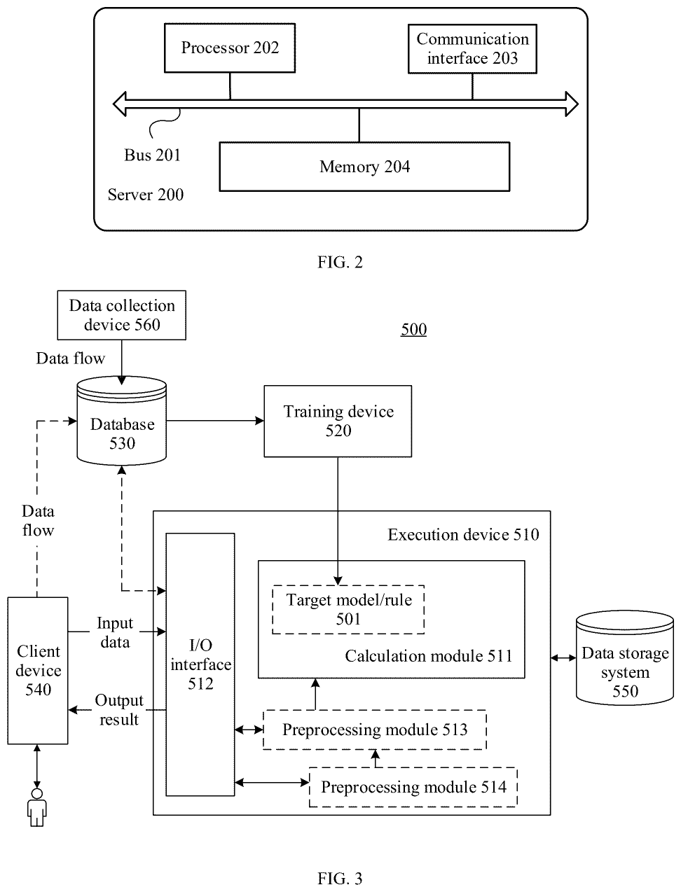

FIG. 2 is a diagram of a structure of the server 200. As shown in FIG. 2, the server 200 includes a bus 201, a processor 202, a communication interface 203, and a memory 204. The processor 202, the memory 204, and the communication interface 203 communicate with each other through the bus 201.

The bus 201 may be a peripheral component interconnect (PCI) bus, an extended industry standard architecture (EISA) bus, or the like. Buses may be classified into an address bus, a data bus, a control bus, and the like. For ease of representation, only one thick line is used to represent the bus in FIG. 2, but this does not mean that there is only one bus or only one type of bus.

The processor 202 may be any one or more of processors such as a central processing unit (CPU), a graphics processing unit (GPU), a microprocessor (MP), or a digital signal processor (DSP).

The memory 204 may include a volatile memory (volatile memory), for example, a random access memory (RAM). The memory 204 may further include a non-volatile memory (non-volatile memory), for example, a read-only memory (ROM), a flash memory, a hard disk drive (HDD), or a solid-state drive (SSD).

The memory 204 may be configured to store software code related to the data processing method. The processor 202 may perform operations of the data processing method of a chip, or may schedule another unit to implement a corresponding function.

It should be understood that the terminal 100 and the server 200 may be central or distributed devices. Processors (for example, the processor 170 and the processor 202) in the terminal 100 and the server 200 each may be a hardware circuit (for example, an application-specific integrated circuit (ASIC), a field-programmable gate array (FPGA), a general-purpose processor, a digital signal processor (DSP), a microprocessor, or a microcontroller), or a combination of these hardware circuits. For example, the processor may be a hardware system that has an instruction execution function, for example, a CPU or a DSP, or may be a hardware system that does not have an instruction execution function, for example, an ASIC or an FPGA, or may be a combination of the hardware system that does not have the instruction execution function and the hardware system that has the instruction execution function.

It should be understood that operations related to a model inference process in embodiments of this application relate to an AI-related operation. When the AI operation is performed, an instruction execution architecture of the terminal device and the server is not limited to the architecture in which the processor and the memory are combined. The system architecture provided in embodiments of this application is described in detail below with reference to FIG. 3.

FIG. 3 is a diagram of a system architecture according to an embodiment of this application. As shown in FIG. 3, the system architecture 500 includes an execution device 510, a training device 520, a database 530, a client device 540, a data storage system 550, and a data collection device 560.

The execution device 510 includes a calculation module 511, an I/O interface 512, a preprocessing module 513, and a preprocessing module 514. The calculation module 511 may include a target model/rule 501, and the preprocessing module 513 and the preprocessing module 514 are optional.

The execution device 510 may be the terminal device or the server that runs the natural language synthesis application.

The data collection device 560 is configured to collect a training sample. The training sample may be image data, text data, or the like. After collecting the training sample, the data collection device 560 stores the training sample in the database 530.

The training device 520 may train a to-be-trained neural network (for example, a neural network model (for example, including a text encoder and a diffusion model) in embodiments of this application) based on the training sample maintained in the database 530, to obtain the target model/rule 501.

It should be understood that the training device 520 may perform a pre-training process on the to-be-trained neural network based on the training sample maintained in the database 530, or perform fine-tuning on a model based on pre-training.

It should be noted that in an actual application, the training sample maintained in the database 530 is not necessarily collected by the data collection device 560, and may be received from another device. In addition, it should be noted that the training device 520 does not necessarily completely train the target model/rule 501 based on the training sample maintained in the database 530, and may perform model training by obtaining a training sample from a cloud or another position. The foregoing descriptions should not be construed as a limitation on an embodiment of the application.

The target model/rule 501 obtained through training by the training device 520 may be applied to different systems or devices, for example, applied to the execution device 510 shown in FIG. 3. The execution device 510 may be a terminal, for example, a mobile phone terminal, a tablet computer, a notebook computer, an augmented reality (AR)/virtual reality (VR) device, or a vehicle-mounted terminal; or may be a server or the like.

In an embodiment, the training device 520 may transfer a trained model to the execution device 510.

In FIG. 3, the input/output (I/O) interface 512 is configured for the execution device 510, and is configured to exchange data with an external device. A user may input data (for example, image data or text data in embodiments of this application) to the I/O interface 512 through the client device 540.

The preprocessing module 513 and the preprocessing module 514 are configured to perform preprocessing based on the input data received by the I/O interface 512. It should be understood that the preprocessing module 513 and the preprocessing module 514 may not exist, or there may be only one preprocessing module. When the preprocessing module 513 and the preprocessing module 514 do not exist, the calculation module 511 may be directly used to process the input data.

When the execution device 510 preprocesses the input data, or when the calculation module 511 in the execution device 510 performs a related processing process such as calculation, the execution device 510 may invoke data, code, and the like in the data storage system 550 for corresponding processing, and may store data, instructions, and the like obtained through corresponding processing into the data storage system 550.

Finally, the I/O interface 512 provides a processing result for the client device 540, to provide the processing result for the user.

In the case shown in FIG. 3, the user may manually give input data, and “manually giving the input data” may be operated on an interface provided by the I/O interface 512. In another case, the client device 540 may automatically send the input data to the I/O interface 512. If the client device 540 is required to automatically send the input data, authorization from the user needs to be obtained, and the user may set corresponding permission in the client device 540. The user may view, on the client device 540, a result output by the execution device 510. The result may be presented in a manner, for example, display, sound, or an action. The client device 540 may also be used as a data collection terminal, collect the input data that is input to the I/O interface 512 and that is shown in the figure and the output result output from the I/O interface 512, use the input data and the output result as new sample data, and store the new sample data in the database 530. Certainly, the client device 540 may alternatively not perform collection. Instead, the I/O interface 512 directly stores, in the database 530 as new sample data, the input data input to the I/O interface 512 and the output result output from the I/O interface 512 that are shown in the figure.

It should be noted that FIG. 3 is merely a diagram of a system architecture according to an embodiment of this application. A location relationship between devices, components, modules, and the like as shown in the figure does not constitute any limitation. For example, in FIG. 3, the data storage system 550 is an external memory relative to the execution device 510. In another case, the data storage system 550 may alternatively be disposed in the execution device 510. It should be understood that the execution device 510 may be deployed in the client device 540.

Details from a perspective of model inference are as follows.

In embodiments of this application, the calculation module 511 in the execution device 510 may obtain the code stored in the data storage system 550, to implement operations related to a model inference process in embodiments of this application.

In embodiments of this application, the calculation module 511 of the execution device 510 may include a hardware circuit (for example, an application-specific integrated circuit (ASIC), a field-programmable gate array (FPGA), a general-purpose processor, a digital signal processor (DSP), a microprocessor, or a microcontroller), or a combination of these hardware circuits. For example, the training device 520 may be a hardware system that has an instruction execution function, for example, a CPU or a DSP, or may be a hardware system that does not have an instruction execution function, for example, an ASIC or an FPGA, or may be a combination of the hardware system that does not have the instruction execution function and the hardware system that has the instruction execution function.

In an embodiment, the calculation module 511 in the execution device 510 may be the hardware system that has the instruction execution function. The operations related to the model inference process provided in embodiments of this application may be software code stored in a memory. The calculation module 511 in the execution device 510 may obtain the software code from the memory, and execute the obtained software code to implement the operations related to the model inference process provided in embodiments of this application.

It should be understood that the calculation module 511 in the execution device 510 may be the combination of the hardware system that does not have the instruction execution function and the hardware system that has the instruction execution function. Some of the operations related to the model inference process provided in embodiments of this application may alternatively be implemented by the hardware system that does not have the instruction execution function in the calculation module 511 in the execution device 510. This is not limited herein.

Details from a perspective of model training are as follows.

In embodiments of this application, the training device 520 may obtain code stored in a memory (which is not shown in FIG. 3, and may be integrated into the training device 520 or separately deployed from the training device 520), to implement operations related to model training in embodiments of this application.

In embodiments of this application, the training device 520 may include a hardware circuit (for example, an application-specific integrated circuit (ASIC), a field-programmable gate array (FPGA), a general-purpose processor, a digital signal processor (DSP), a microprocessor, or a microcontroller), or a combination of these hardware circuits. For example, the training device 520 may be a hardware system that has an instruction execution function, for example, a CPU or a DSP, or may be a hardware system that does not have an instruction execution function, for example, an ASIC or an FPGA, or may be a combination of the hardware system that does not have the instruction execution function and the hardware system that has the instruction execution function.

It should be understood that the training device 520 may be the combination of the hardware system that does not have the instruction execution function and the hardware system that has the instruction execution function. Some of the operations related to model training provided in embodiments of this application may alternatively be implemented by the hardware system that does not have the instruction execution function in the training device 520. This is not limited herein.

### 2. Natural Language Synthesis Function Cloud Service Provided by a Server

In an embodiment, the server may provide a natural language synthesis function service for a terminal side through an application programming interface (API).

A terminal device may send a related parameter (for example, data such as a text) to the server through the API provided by the cloud. The server may obtain a processing result or the like based on the received parameter, and return the processing result to the terminal. For descriptions of the terminal and the server, refer to the descriptions in the foregoing embodiments. Details are not described herein again.

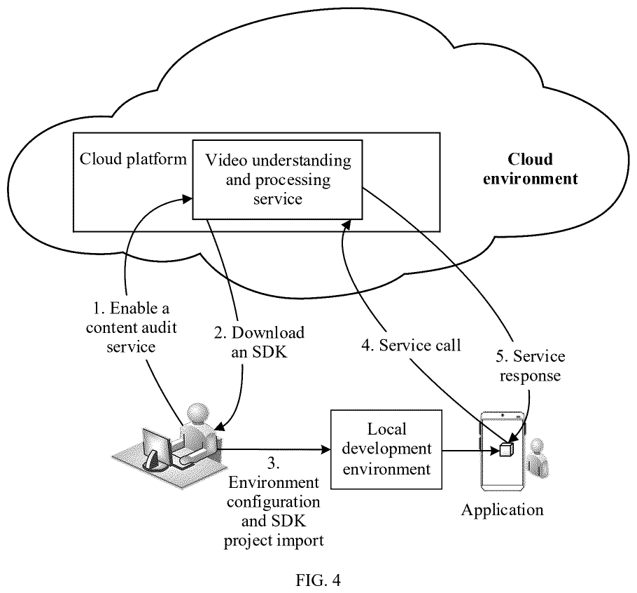

FIG. 4 shows a process of using a natural language synthesis function cloud service provided by a cloud platform.

1. Enable and purchase a content audit service

2. The user can download a software development kit (SDK) corresponding to the content audit service. Usually, the cloud platform provides SDKs of a plurality of development versions for selection by the user according to a development environment requirement, for example, a Java-version SDK, a Python-version SDK, a PHP-version SDK, and an Android-version SDK.

3. After locally downloading an SDK of a corresponding version as required, the user imports an SDK project to a local development environment, and performs configuration and debugging in the local development environment. Another function may be further developed in the local development environment, to form an application that integrates a natural language synthesis function capability.

4. During use of a natural language synthesis function application, when a natural language synthesis function is required, an API call for the natural language synthesis function may be triggered. When an application triggers the natural language synthesis function, an API request is initiated to a running instance of a natural language synthesis function service in a cloud environment. The API request carries the text, and the running instance in the cloud environment processes the text to obtain a processing result.

5. The cloud environment returns the processing result to the application. In this way, the natural language synthesis function is invoked once.

Embodiments of this application relate to massive application of a neural network. Therefore, for ease of understanding, the following first describes related terms and related concepts such as the neural network in embodiments of this application.

### (1) Neural Network

The neural network may include a neuron. The neuron may be an operation unit that uses xs (namely, input data) and an intercept of 1 as an input. An output of the operation unit may be as follows:

$${h}_{W , b} ( x ) = f ( {W}^{T} x ) = f ( {\sum }_{s = 1}^{n} {W}_{s} {x}_{s} + b ) .$$

Herein, s=1, 2, . . . , and n. n is a natural number greater than 1. Ws is a weight of xs. b is a bias of the neuron. f is an activation function of the neuron, and is used to introduce a non-linear characteristic into the neural network, to convert an input signal in the neuron into an output signal. The output signal of the activation function may be used as an input of a next convolutional layer, and the activation function may be a sigmoid function. The neural network is a network formed by connecting a plurality of single neurons together. In an embodiment, an output of one neuron may be an input to another neuron. An input of each neuron may be connected to a local receptive field of a previous layer to extract a feature of the local receptive field. The local receptive field may be a region including several neurons.

### (2) Transformer Layer

A neural network includes an embedding layer and at least one transformer layer. The at least one transformer layer may be N transformer layers (N is an integer greater than 0), and each transformer layer includes an attention layer, an add and normalization (add & norm) layer, a feedforward layer, and an add and normalization layer that are sequentially adjacent to each other. At the embedding layer, embedding processing is performed on a current input to obtain a plurality of embedding vectors. At the attention layer, P input vectors are obtained from a previous layer of a first transformer layer. Any first input vector in the P input vectors is used as a center. An intermediate vector corresponding to the first input vector is obtained based on an association degree between the first input vector and each input vector within a preset attention window range. In this way, P intermediate vectors corresponding to the P input vectors are determined. At a pooling layer, the P intermediate vectors are merged into Q output vectors. A plurality of output vectors obtained from a last transformer layer in transformer layers are used as feature representations of the current input.

### (3) Attention Mechanism

The attention mechanism simulates an internal process of an observational behavior of a creature, is a mechanism that aligns internal experience with external feelings to increase observation precision of some regions, and can quickly select high-value information from a large amount of information by using limited attention resources. The attention mechanism can quickly extract an important feature of sparse data, and therefore is widely used in natural language processing tasks, especially machine translation. A self-attention mechanism is improvement of the attention mechanism. The self-attention mechanism becomes less dependent on external information and is better at capturing an internal correlation of data or features. An essential idea of the attention mechanism may be rewritten as the following formula:

Herein, Lx=∥Source∥ represents a length of a source. The formula means that constituent elements in the source are assumed to include a series of data pairs. In this case, an element query in a target is provided, similarity or a correlation between the query and each key is calculated to obtain a weight coefficient of a value corresponding to each key, and then weighted summation is performed on values, to obtain a final attention value. Therefore, in essence, the attention mechanism is to perform weighted summation on values of the elements in the source, and a query and key are used to calculate a weight coefficient of a corresponding value. Conceptually, attention may be understood as selecting a small amount of important information from a large amount of information, focusing on the important information, and ignoring most of unimportant information. A process of focusing is reflected in calculation of the weight coefficient. A greater weight indicates that a value corresponding to the weight is more focused, that is, the weight indicates importance of information, and the value is the information corresponding to the weight. The self-attention mechanism may be understood as an intra-attention mechanism. The attention mechanism occurs between the element query in the target and all the elements in the source. The self-attention mechanism is an attention mechanism that occurs between elements in a source or between elements in a target, and may also be understood as an attention calculation mechanism in a special case of Target=Source. A calculation process of the self-attention mechanism is the same except that a calculation object changes.

### (4) Natural Language Processing (NLP)

A natural language is a human language, and natural language processing (NLP) is processing of the human language. Natural language processing is a process of systematic analysis, understanding, and information extraction of text data in an intelligent and efficient manner. By using NLP and components of NLP, massive chunks of text data can be managed, or a large quantity of automated tasks can be executed, and various problems such as automatic summarization, machine translation (MT), named entity recognition (NER), relation extraction (RE), information extraction (IE), sentiment analysis, speech recognition, a question answering system, and topic segmentation can be resolved.

### (5) Back Propagation Algorithm

The convolutional neural network may correct a value of a parameter in an initial super-resolution model in a training process according to an error back propagation (BP) algorithm, so that an error loss of reconstructing the super-resolution model becomes smaller. In an embodiment, an input signal is transferred forward until an error loss occurs at an output, and the parameter in the initial super-resolution model is updated based on back propagation error loss information, to converge the error loss. The back propagation algorithm is an error-loss-centered back propagation motion intended to obtain a parameter, such as a weight matrix, of an optimal super-resolution model.

### (6) Loss Function

In a process of training a deep neural network, because it is expected that an output of the deep neural network is as close as possible to a predicted value that is actually expected, a predicted value of a current network may be compared with a target value that is actually expected, and then a weight vector at each layer of the neural network is updated based on a difference between the predicted value and the target value (certainly, there is usually an initialization process before a first update, that is, a parameter is preconfigured for each layer of the deep neural network). For example, if the predicted value of the network is large, the weight vector is adjusted to decrease the predicted value, and adjustment is continuously performed, until the deep neural network can predict the target value that is actually expected or a value that is very close to the target value that is actually expected. Therefore, “how to obtain, through comparison, the difference between the predicted value and the target value” needs to be predefined. This is a loss function or an objective function. The loss function and the objective function are important equations that are used to measure the difference between the predicted value and the target value. The loss function is used as an example. A higher output value (loss) of the loss function indicates a larger difference. Therefore, training of the deep neural network is a process of minimizing the loss as much as possible.

### (7) Pre-Trained Language Model

The pre-trained language model is a natural language sequence encoder, and encodes each word in a natural language sequence into a vector representation to perform a prediction task. Training for the pre-trained language model includes two stages. At a pre-training stage, the model is trained for a language model task on a large scale of an unsupervised text to learn a word representation. At a fine-tuning stage, the model is initialized by using parameters learned at the pre-training stage, and is trained in few operations on downstream tasks such as text classification and sequence labeling, so that semantic information obtained through pre-training can be successfully migrated to the downstream tasks.

It should be understood that the foregoing architecture may be further applied to another natural language processing task, for example, natural language synthesis, semantic understanding, or summary generation.

### (8) Average Pooling

Average pooling means that an average value of all representations in a representation set is used as a representation of the representation set during forward propagation of the model.

Since the release of ChatGPT, capabilities and future potential of large foundation models (for example, large language models (LLMs)) have received widespread attention from all walks of life. Large models can usually process a limited input length. For example, ChatGPT can process a maximum length of 4096 tokens, while GPT-4 can process a maximum length of 30000 tokens. However, in reality, there is a large amount of long-sequence information, such as papers, books, multiple documents, long conference information, and long code information. In addition, when the large models engage in conversations with users, processing of long conversation historical information is also involved.

Therefore, there is an urgent need for a method that can improve a long-sequence processing capability of the large models.

The data processing method provided in embodiments of this application is first described by using a model training stage as an example.

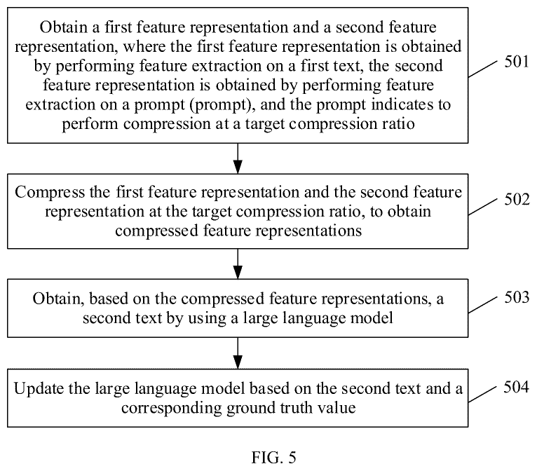

FIG. 5 is a diagram of an embodiment of a data processing method according to an embodiment of this application. The data processing method provided in an embodiment of the application may be applied to a terminal device such as a mobile phone, a tablet computer, a notebook computer, or a smart wearable device, or may be applied to a server. As shown in FIG. 5, the data processing method provided in an embodiment of the application includes the following operations.

501: Obtain a first feature representation and a second feature representation, where the first feature representation is obtained by performing feature extraction on a first text, the second feature representation is obtained by performing feature extraction on a prompt, and the prompt indicates to perform compression at a target compression ratio.

In an embodiment, the first text may be a training sample for the large language model. The training sample may include the first text and a ground truth value corresponding to the first text. The first text may be obtained based on a source corpus, the ground truth value corresponding to the first text may be obtained based on a target corpus, and the large language model needs to predict and generate the target corpus based on the source corpus.

For example, the first text may be: “Please generate a summary of the following text: ‘XXXX’”.

The first text may be a long-sequence text. For example, the first text may include book content, long papers, long videos, multiple code files, multiple documents, high-resolution images, extended mathematical proofs, multi-turn conversation content, and the like.

In an embodiment, the large language model may be used for a sequence conversion task between different language types, for example, a text translation task or a summary generation task between different languages. In this case, the first text and the ground truth value corresponding to the first text may be texts of different language types (it is not required that all data units in the first text are of different language types from data units in the ground truth value corresponding to the first text; for example, some of the data units in the first text are of the same language type as data units (some or all of the data units) in the ground truth value corresponding to the first text). The language type may also be referred to as a language.

For example, in a Chinese-English translation task, an original text is “zhe ci lv xing xu yao ren zhen ji hua”, and an English text corresponding to the original text in parallel is “The trip needs careful planning”. In this case, “zhe ci lv xing xu yao ren zhen ji hua” and “The trip needs careful planning” may be considered as a group of parallel corpora, and the group of parallel corpora is a Chinese-English parallel language pair. The original text “zhe ci lv xing xu yao ren zhen ji hua” may be considered as a source corpus of the group of parallel corpora, and the translated text “The trip needs careful planning” may be considered as a target corpus of the group of parallel corpora.

For example, in an English-German translation task, an original text is “We dance on the grass”, and a German text corresponding to the original text in parallel is “Wir tanzen auf dem gras”. In this case, “We dance on the grass” and “Wir tanzen auf dem gras” may be considered as a group of parallel corpora, and the group of parallel corpora is an English-German parallel language pair. The original text “We dance on the grass” may be considered as a source corpus of the group of parallel corpora, and the translated text “Wir tanzen auf dem gras” may be considered as a target corpus of the group of parallel corpora.

In an embodiment, the large language model may be configured to implement a summary generation task of a text. In this case, the source corpus may be a source corpus from which a summarization needs to be extracted, and the target corpus may be a summarization text that needs to be generated.

In an embodiment, the large language model may be configured to implement a text reply task. In this case, the source corpus may be a source corpus that needs to be replied, and the target corpus may be reply content for the source corpus.

In an embodiment, the original source corpus and the original target corpus may be obtained from an external database.

In an embodiment, feature extraction may be performed on the first text to obtain the first feature representation. The first feature representation may be obtained by performing feature extraction on the first text by using an embedding layer of the large language model, or the first feature representation may be obtained by performing feature extraction on the first text by using an embedding layer in a text encoder (description of the text encoder is described in a subsequent embodiment).

In an embodiment, the embedding layer may obtain token embedding, position embedding, and segment embedding (segment embedding is optional) of each data unit of the first text.

In an embodiment, the embedding layer may include an input embedding layer and a positional encoding layer. At the input embedding layer, token embedding processing may be performed on each data unit in unmasked data units in a current input, to obtain a word vector (for example, may indicate semantic information) of each data unit in the unmasked data units. At the positional encoding layer, a position, in the current input, of each data unit in the unmasked data units may be obtained, to generate a position vector for the position of each data unit in the unmasked data units.

In some examples, position information of each data unit in the unmasked data units in the data sequence may be an absolute position of each data unit in the unmasked data units in the data sequence. For example, the current input is “What date should the Huabei debt be repaid (ji hao ying huan hua bei)”, where a position of “what (ji)” may be represented as a first position, a position of “date (hao)” may be represented as a second position, and so on. In some examples, the position of each data unit in the unmasked data units in the data sequence may be a relative position of each data unit in the unmasked data units in the data sequence. For example, the current input is still “What date should the Huabei debt be repaid (ji hao ying huan hua bei)”, where a position of “what (ji)” may be represented as preceding “date (hao)”, the position of “date (hao)” may be represented as following “what (ji)” and preceding “should (ying)”, and so on. When the word vector and the position vector of each data unit in the unmasked data units in the current input are obtained, the position vector of each data unit in the unmasked data units and the corresponding word vector may be fused, to obtain the embedding vector of each data unit in the unmasked data units. It should be understood that a fusion manner may be performing an addition operation on the position vector and the corresponding word vector, or performing another operation. A fusion manner is not limited herein. The embedding vector may be represented as an embedding matrix having a preset dimension. A quantity of embedding vectors may be set to M, and the preset dimension is H dimensions. In this case, the embedding vector may be represented as an M×H embedding matrix.

When the first text is a long sequence, especially when the first text exceeds a maximum input length that can be supported by the large language model, a feature representation of the first text needs to be compressed, so that the compressed feature representation can be processed by the large language model.

In an embodiment, in addition to the first text, a prompt may further be obtained, and the prompt may indicate to perform compression at a target compression ratio. The compression ratio may be a ratio of a compressed size to an uncompressed size of data.

One reason for defining the compression ratio in the prompt is that the compressed feature representation has a degree of information loss in terms of size and content compared to an uncompressed input. Therefore, the compression ratio carried in the prompt can provide the large model with a priori knowledge of compression information, so that the large model can generate a more accurate reply text when there is an input loss. In addition, when the compression manner is compression performed by using a neural network (which may be referred to as a compression model for short), the compression ratio carried in the prompt can also provide the compression model with a priori knowledge of compression information, so that the compression model enables the compressed feature representation to retain more valid information.

In an embodiment, the prompt further indicates the compression manner of the compression.

The compression manner may be average pooling, or compression based on a neural network.

Similarly, the compression manner of the compression is carried in the prompt to provide the large model with richer a priori knowledge of compression information, so that the large model can generate a more accurate reply text when there is an input loss.

For example, the prompt may be: “This is a representation sequence compressed to a 20% length using an average pooling method, and please respond based on an original text of the representation sequence:”. For another example, the prompt may be: “This is a representation sequence compressed to a 20% length using an average pooling method, and please reconstruct an original text:”.

The following describes how to determine the target compression ratio.

In an embodiment, the target compression ratio may be specified by a user, or may be determined by a system based on a relationship between the first text and the maximum input length supported by the large language model. For example, the target compression ratio may be determined based on a ratio (X/Y) of the maximum input length X supported by the large language model to a length Y of the first text, where the target compression ratio may be less than or equal to the ratio (X/Y).

It should be understood that the prompt carrying the compression information may be information input by the user, or may be automatically generated by the system. This is not limited in this application.

It should be understood that the long sequence may also internally include a task-specific prompt, so that a nested relationship may exist between two levels of prompts. Prompt information that represents a task is more important. Therefore, when the prompt is short, a parallel arrangement may be used, that is, a prompt related to the task and a prompt that represents the compression ratio can be placed together.

Example 1: (nested mode): “This is a representation sequence compressed to a 20% length using an average pooling method, and please respond based on an original text of the representation sequence: [Generate a summary of 100 words or less based on the following content:]”.

Example 2: (parallel mode): “Generate a summary of 100 words or less based on the following representation sequence compressed to a 20% length using an average pooling method:”.

502: Compress the first feature representation and the second feature representation at the target compression ratio, to obtain compressed feature representations.

In an embodiment, the first feature representation and the second feature representation may be compressed at the target compression ratio by using an average pooling operation, to obtain the compressed feature representations.

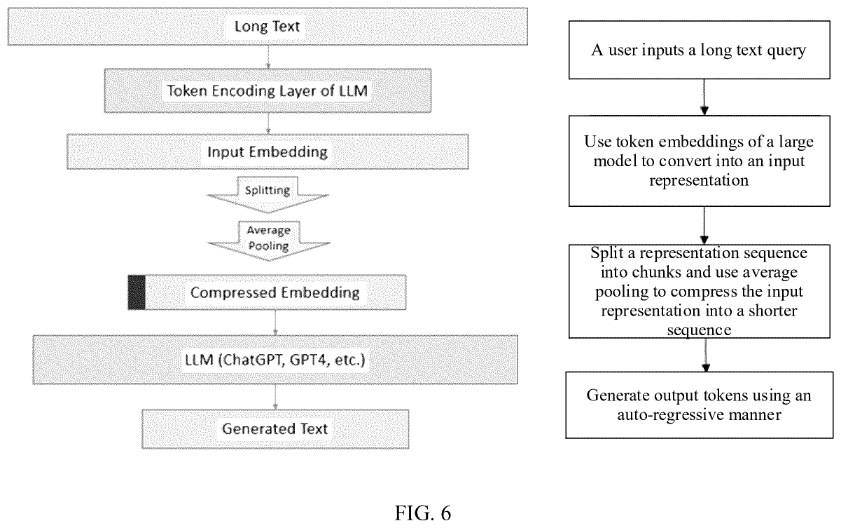

FIG. 6 is a diagram of feature representation compression and large model generation based on average pooling and an inference process. In an embodiment, an input text or a sequence of another type may be converted into token ids, and a representation of an original sequence is generated by using the embedding layer. The representation sequence is split into chunks based on a window size. A representation vector of each chunk is obtained by averaging the chunk of representation sequence. These average representation vectors are sequentially concatenated to form a compressed representation vector of the original sequence.

In an embodiment, the first feature representation and the second feature representation may be compressed at the target compression ratio by using the text encoder, to obtain the compressed feature representations.

In an embodiment, the compression manner of the compression is compression based on the text encoder (which may also be referred to as a compression model). The first feature representation and the second feature representation may be encoded by using the text encoder, to obtain encoding results. Some of the encoding results are used as the compressed feature representations. The some encoding results are a proportion, equal to the target compression ratio, of encoding results extracted from the encoding results.

For example, if the target compression ratio is 0.3, 30 percent of feature representations from the encoding results may be used as the compressed feature representations. For example, the first 30 percent of feature representations may be selected as the compressed feature representations.

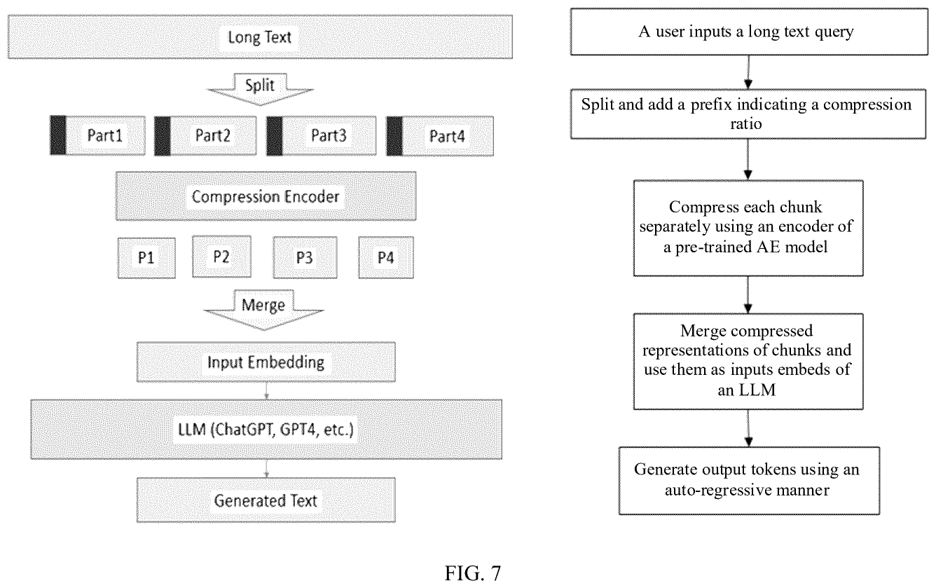

FIG. 7 is a diagram of feature representation compression and large model generation based on a compression model and an inference process. In an embodiment, the compression model may use a compression model that is pre-trained by using an autoencoder structure, and the compression model may compress an original long text into a short representation sequence. In an embodiment, when an input sequence is excessively long or includes multiple documents, the sequence may be segmented (or may be described as splitting) and separately compressed. In other words, in an embodiment, the first feature representation and the second feature representation may be split, to obtain a plurality of sub-feature representations. Each of the plurality of sub-feature representations is compressed at the target compression ratio.

After each sub-feature representation is compressed at the target compression ratio, a plurality of compressed sub-feature representations may be obtained, and the plurality of compressed sub-feature representations may be fused (for example, concatenated (concat)) to obtain a compressed feature representation.

In an embodiment, the compression manner of the compression is the compression based on the text encoder. When the text encoder is trained, a predicted value of the first text and the prompt may be obtained based on the compressed feature representations (for example, some of feature representations obtained by using the text encoder are selected, and the others may be masked) by using a text decoder. The text encoder is updated based on the first text, the prompt, and the predicted value.

The first text and the prompt are equivalent to a ground truth value. Therefore, a loss may be determined based on a difference between the predicted value and the ground truth value, and the text encoder may be updated based on the loss. Certainly, the text decoder may also be updated. When the text decoder is a pre-trained decoder, the text decoder may not be updated.

Through training of the compression model, the text decoder can obtain an accurate original text based on the compressed feature representations obtained by using the text encoder. In addition, the text decoder can still restore the original sequence based on the compressed feature representations only when the compressed feature representations obtained by using the text encoder carries rich information (that is, much valid information is not lost in a compression process). Therefore, the foregoing training process may enable the text encoder to have a capability of not losing much valid information in a compression process, so that the large language model can subsequently obtain a more accurate reply text.

It should be understood that the foregoing training process of the compression model may be performed before the training process of the large language model (that is, the compression model used in operation 502 is a pre-trained model, and does not need to be updated in the training process of the large language model), or may be end-to-end trained together with the large language model (that is, the compression model also needs to be updated in the training process of the large language model). This is not limited in this application.

For example, a training manner of the compression model may be as follows.

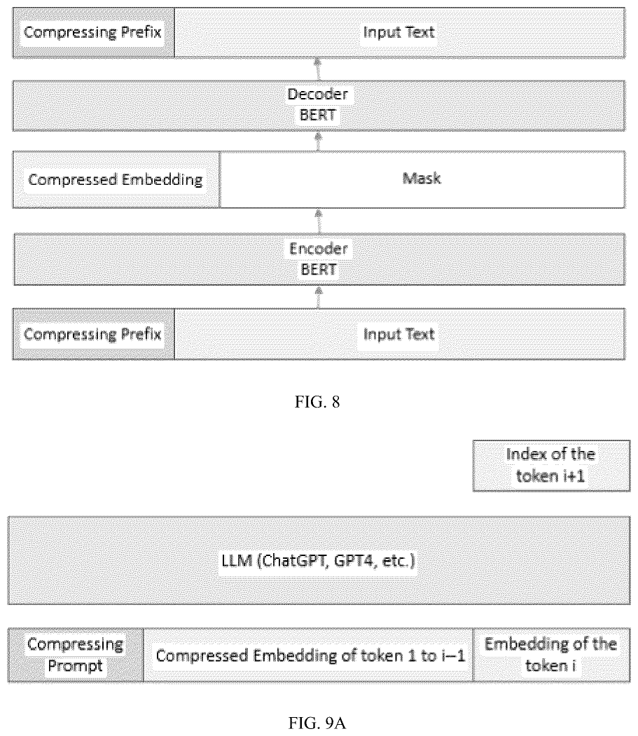

FIG. 8 is a diagram of a processing procedure in which both an encoder side and a decoder side are of a BERT structure. As shown in FIG. 8, a prompt based on compression ratio information (for example, the target compression ratio in embodiments of this application) may be constructed and may be represented by text. The information and an input text (for example, the first text in embodiments of this application) are concatenated, and then token ids of an entire input sequence are generated by using a tokenizer layer. The token ids of the entire input sequence are then input to an encoder model as input ids. Top vectors of the encoder model are selected as a top representation sequence (for example, the compressed feature representations in embodiments of this application) of corresponding input information. Only a front portion of the top representation sequence output by the encoder is selected based on the compression ratio, and a masking (mask) method may be used. The selected top representation sequence is used as input embedding, and is input to a decoder part of the compression model. An output representation sequence is then converted into logits to fit token ids information of an original text. If GPT is used as the decoder module, a teacher forcing method can be used for training. The model is trained by minimizing a reconstruction loss, thereby ensuring that the front portion (determined by the compression ratio) of the top representation sequence output by the encoder can be used by the decoder to reconstruct the original text.

A main function of the compression model is to compress a long sequence into representation sequences of different lengths according to a specified compression ratio, and a compressed representation sequence can well reconstruct an original input sequence by using the decoder model.

In such a compression model-based method, various autoencoder structures may be used, including using a transformer encoder structure such as BERT, Longformer, Bigbird, XLNet at an encoder side, and using a transformer encoder or decoder structure such as BERT or GPT at a decoder side.

In addition, to adapt to a long sequence, a feedforward propagation manner of segmentation-encoding-decoding-concatenation may be used. Alternatively, a sparse transformer structure may be used as the encoder, such as Longformer, Bigbird, or XLNet.

503: Obtain, based on the compressed feature representations, a second text by using the large language model.

504: Update the large language model based on the second text and a corresponding ground truth value.

In an embodiment, the compressed feature representations may be input to the large language model, and the large language model may process the compressed feature representations to obtain the second text.

It should be understood that, when the compressed feature representations are input to the large model, the input sequence may incorporate, at a prefix or another position, representations corresponding to a prompt that includes the target compression ratio. When the compression model is used to compress the feature representations, input content of the compression model may include prompt information, and the compressed feature representations do not strictly distinguish between portions corresponding to the text content and the prompt information (because both are jointly used as an input to the compression model).

In an embodiment, the second text may be obtained based on the compressed feature representations and the second feature representation and by using the large language model. In other words, the second feature representation may be input to the large language model together with the compressed feature representations as an input, or the second feature representation may not be input to the large language model together with the compressed feature representation as an input.

In a case of end-to-end training of the large language model and the compression model, the large language model may spontaneously learn to use prompt information in the compressed representations. Therefore, the second feature representation may not be input to the large model, and instead, corresponding prompt information in the encoding results obtained by using the compression model is used.

In an embodiment, a feature representation output by a hidden layer of the large language model may further be obtained based on the compressed feature representations and by using the large language model. The second text is obtained by using the text decoder based on the feature representation output by the hidden layer.

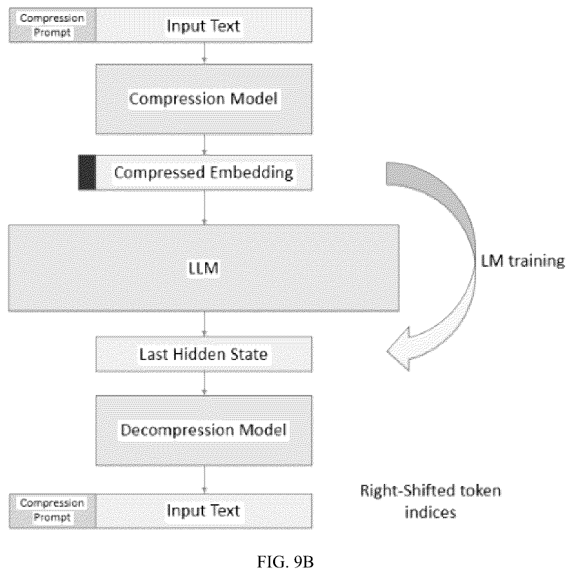

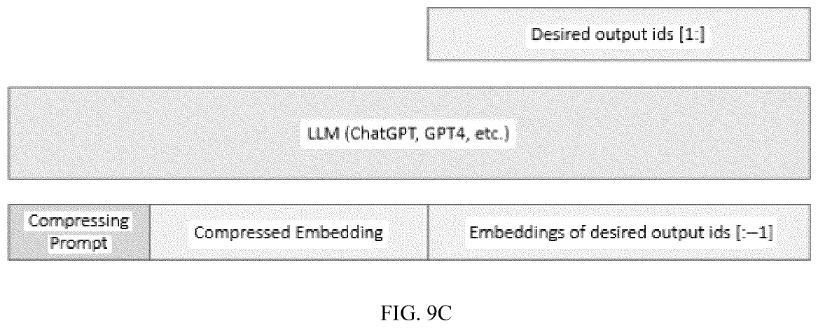

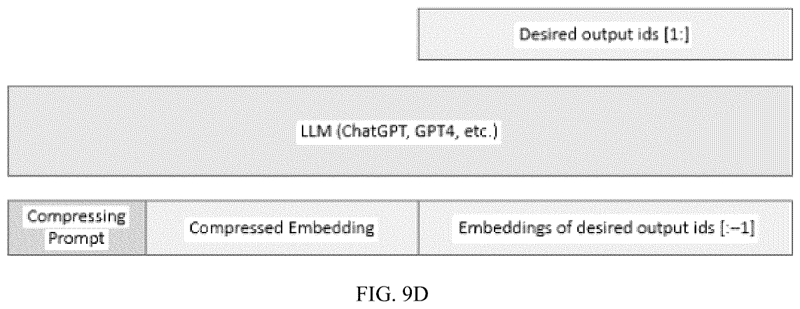

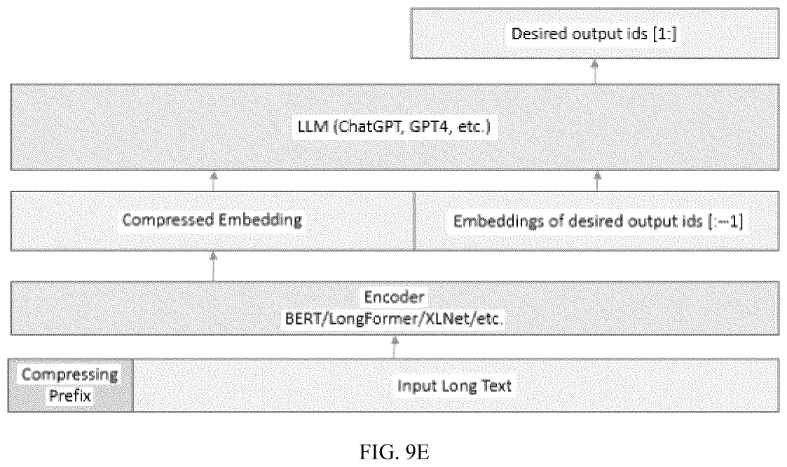

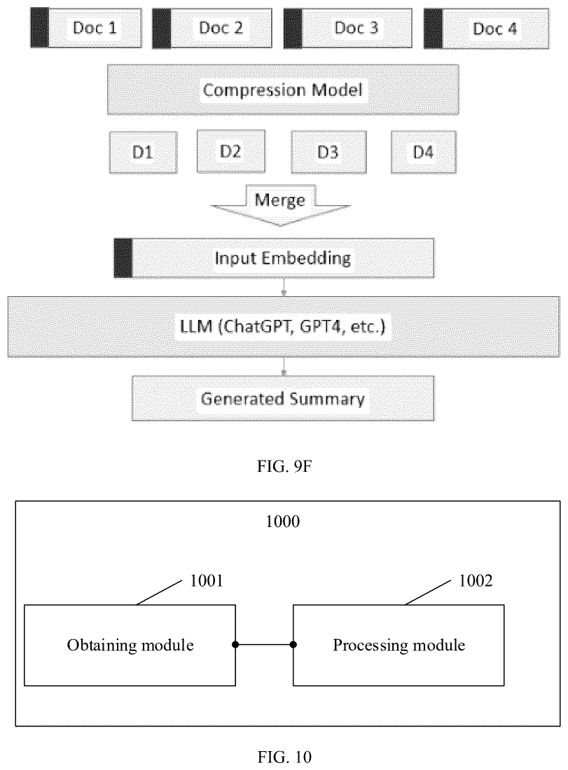

A text finally output by the large model may be directly used as a reply text (that is, tokens are generated by using an uncompressed sequence). This case is applicable to a scenario in which a long input and a short output are used. An embodiment of the application may be further extended to processing within compression representation space of an entire sequence (that is, may be applicable to a long output). Refer to FIG. 9B. The large language model inputs the compressed feature representations, and trains the language model by using a translation relationship represented by an input-output hidden layer. Each representation vector does not directly correspond to one token in an original vocabulary. Hidden layer representations at an output end may restore output text information by using the decoder of the compression model. In addition, during training in the representation space, because each representation vector does not directly correspond to a one-hot vector from the original vocabulary, the loss function may be defined based on a cosine similarity or a mean squared error (MSE) between a predicted representation vector and an actual representation vector.

In an embodiment, the embodiment corresponding to FIG. 5 may be applied to a process of continued pre-training of the large language model. In other words, the large language model is already a pre-trained large model, and there is an upper limit of a length that can be processed by the large language model, for example, 2048 tokens. In an embodiment of the application, continued pre-training of a long sequence may be performed based on this model, so that the model can process a longer input sequence. FIG. 9A is a diagram of continued pre-training of the large model based on a compressed sequence. A main procedure is as follows: A sequence compression ratio is determined based on information such as an original sequence length. The sequence compression ratio is written into a prompt. A prompt text is processed by an embedding layer of the large model to obtain a corresponding embedding. A compressed representation of the original sequence is obtained using average pooling or a compression model. The embedding of the prompt, compressed sequence representation of 1^{st} to (i−1)^{th} tokens from the original sequence, and a representation of an i^{th} token of the original sequence are concatenated and input to a portion of the large model following the embedding layer, and an (i+1)^{th} token of the original sequence is predicted based on an output at a last position. Model training is performed based on an amount of data with different lengths and compression ratios. Alternatively, the embedding of the prompt and compressed sequence representation of 1^{st} to i^{th} tokens from the original sequence may be used as an input, and an (i+1)^{th} token of the original sequence is predicted based on an output at a last position. In addition, when the compression model is used, the compression model may be connected in series to the large model for end-to-end training.

In an embodiment, the embodiment corresponding to FIG. 5 may be applied to a fine-tuning process of the large language model. In other words, the large language model is already a pre-trained large model, and there is an upper limit of a length that can be processed by the large language model, for example, 2048 tokens. In an embodiment of the application, fine-tuning of a long sequence may be performed based on this model, so that the model can process a longer input sequence. FIG. 9C is a diagram of Finetune of the large model based on a compressed representation. A main operation is to compress an original input sequence into a representation sequence with a shorter length using average pooling or a compression model. A prompt is used to inform the model of a compression ratio used for the sequence, so that the large model can learn to provide a text reply based on content before compression.

Refer to FIG. 9E. A training process is as follows: A compression model or average pooling is used to compress an original sequence or a representation sequence obtained from the original sequence after processing by the embedding layer of the large model into a shorter compressed representation sequence. Information such as the compression ratio is written into a prompt, and the representation sequence of the prompt information is obtained through the embedding layer. The representation sequence of the prompt and a compressed representation sequence of an original input are concatenated and used as an input representation to the large language model. An expected reply is used as an output of the large language model, and a teacher forcing method is used for training. Training is performed across a plurality of different tasks using input data with different lengths and compression ratios, to enhance generalization of the model.

In an embodiment, when the compression model is used to perform supervised fine-tuning (SFT), two manners are considered. One manner is to perform encoding by using an encoder part of a compression model that has been pre-trained by using a large amount of data, and then input the encoder part into the large language model for SFT. The other is to use the pre-trained encoder and the large language model to perform end-to-end SFT simultaneously. When the original input is excessively long, a method of segmented compression followed by merging can be used.

In addition, an end-to-end model training manner may be employed during both continued pre-training and supervised fine-tuning stages. Compared with independent training of the compression model, end-to-end training allows gradients of the large model to be propagated back through the compressed representation sequence to the compression model, so that a parameter in the compression model can be updated. In FIG. 9D, SFT is used as an example for description. In an inference stage, an overall structure may still be referenced.

Beneficial effects of embodiments of this application mainly include the following points.

First, the compression ratio carried in the prompt can provide the large model with a priori knowledge of compression information, so that the large model can generate a more accurate reply text when there is an input loss.

Second, the solution enables a large language model that has a set maximum length and has completed pre-training to adapt to continued pre-training, fine-tuning, and inference of a longer input sequence, without requiring retraining.

Third, a text input can be extended to an infinite length in theory, and dynamic-length text compression is also supported, to adapt to user inputs with different lengths.

Fourth, an arbitrary length input may be mapped to a fixed length, and a theoretical inference latency may be controlled at a complexity of O(1). Therefore, training and inference time and memory consumption for long sequences can be effectively controlled.

The following describes the data processing method in embodiments of this application from a perspective of model inference.

An embodiment of this application provides a data processing method, including:
obtaining a first feature representation and a second feature representation, where the first feature representation is obtained by performing feature extraction on a first text, the second feature representation is obtained by performing feature extraction on a prompt, and the prompt indicates to perform compression at a target compression ratio; compressing the first feature representation and the second feature representation at the target compression ratio, to obtain compressed feature representations; and obtain, based on the compressed feature representations, a second text by using a large language model, where the second text is used as a reply text to the first text.

In an embodiment, the large language model is used to execute a target task, and the target task is one of the following: reading comprehension, text translation, paraphrase identification, named entity recognition, text sentiment analysis, natural language inference, text automatic question answering, text intent recognition, text classification, text simplification, and text story generation.

In an embodiment, a compression manner of the compression includes: an average pooling operation, or compression based on a text encoder.

In an embodiment, the prompt further indicates the compression manner of the compression.

In an embodiment, the first feature representation and the second feature representation may be split, to obtain a plurality of sub-feature representations. Each of the plurality of sub-feature representations is compressed at the target compression ratio.

In an embodiment, the target compression ratio may be further determined based on a relationship between a length of the first text and a maximum input text length supported by the large language model.

In an embodiment, the compression manner of the compression is the compression based on the text encoder. The first feature representation and the second feature representation may be encoded by using the text encoder, to obtain encoding results.

Some of the encoding results are used as the compressed feature representations. The some encoding results are a proportion, equal to the target compression ratio, of encoding results extracted from the encoding results.

In an embodiment, the second text may be obtained based on the compressed feature representations and the second feature representation and by using the large language model.

In an embodiment, a feature representation output by a hidden layer of the large language model may be obtained based on the compressed feature representations and by using the large language model. The second text is obtained by using the text decoder based on the feature representation output by the hidden layer.

For operations performed in the model inference process, refer to operations performed in the feedforward process of the training process. Similarities are not described herein again.

In the inference stage, an appropriate processing manner may be used based on inputs with different lengths from a user. When a user input is shorter than a maximum input length of an original large model, an input sequence is directly input to the large model without passing through a compression module. When a length of the user input exceeds the maximum input length of the original large model, the input sequence needs to pass through the compression module (for example, including the average pooling operation or the compression model), and an appropriate compression ratio is used to compress the original sequence length to within the maximum input length of the large model. In an embodiment, when a length of the user input exceeds a processing length of the compression model, the input sequence may be input to the compression model by segment. The compressed representations are concatenated and subsequently input to the large model.

The following describes two application scenarios of the inference stage in embodiments of this application.

An application scenario of embodiments of this application is an inference scenario for multi-document summarization. Content of each document is separately compressed by the compression module to obtain a compressed representation corresponding to the document. After merging, a prompt that represents a task is added to a prefix or another position, and then the prompt is input to the model. An output is a generated summarization. FIG. 9F is a diagram of SFT and inference of multi-document summarization. A procedure may include the following operations. Based on length distribution of the documents, an appropriate compression ratio and truncation length may be selected. A unified compression ratio prompt and truncation length are then used to compress the documents. Then, a compressed representation sequence is obtained after concatenation. Representation sequences of the documents may be segmented by using a large model representation corresponding to a token such as [SEP]. Representation sequences of a prompt that is of the multi-document summarization task and that is obtained through an embedding layer is concatenated into the original multi-document compressed representation sequence in a prefix or another form, to obtain an input representation sequence. The input representation sequence passes through the large model to obtain output summarization content.

An application scenario of embodiments of this application is long-sequence processing in a multi-turn conversation. Although in most cases, input and output sequence lengths of the large model are not excessively long. However, during actual application, because there is interaction between a user and a model, a long historical conversation record may be formed in a conversation process, for example, some educational scenarios and iterative code generation scenarios. To maintain consistency of conversation content, historical conversation information usually needs to be processed. In this case, it may be considered that when a length of a conversation history exceeds an input length limit of the model, a representation sequence of historical information may be compressed. Compressed representations of the historical information may then be merged with representations of recent conversation content and input to the model, to finally generate a next reply. An embodiment may enhance a multi-turn conversation capability of the large model, and may be applied to scenarios such as education and code generation.

Based on embodiments corresponding to FIG. 1A to FIG. 9F, to better implement the foregoing solutions in embodiments of this application, the following further provides related devices for implementing the foregoing solutions. In an embodiment, FIG. 10 is a diagram of a structure of a data processing device 1000 according to an embodiment of this application. The data processing device 1000 includes the following modules.

An obtaining module 1001 is configured to obtain a first feature representation and a second feature representation. The first feature representation is obtained by performing feature extraction on a first text, the second feature representation is obtained by performing feature extraction on a prompt, and the prompt indicates to perform compression at a target compression ratio.

For descriptions of the obtaining module 1001, refer to the descriptions of operation 501 in the foregoing embodiment. Details are not described herein again.

A processing module 1002 is configured to: compress the first feature representation and the second feature representation at the target compression ratio, to obtain compressed feature representations;
obtain, based on the compressed feature representations, a second text by using a large language model; and
update the large language model based on the second text and a corresponding ground truth value.

For descriptions of the processing module 1002, refer to the descriptions of operation 502 to operation 504 in the foregoing embodiment. Details are not described herein again.

In an embodiment, the large language model is used to execute a target task, and the target task is one of the following:
reading comprehension, text translation, paraphrase identification, named entity recognition, text sentiment analysis, natural language inference, text automatic question answering, text intent recognition, text classification, text simplification, and text story generation.

In an embodiment, a compression manner of the compression includes:
an average pooling operation, or compression based on a text encoder.

In an embodiment, the prompt further indicates the compression manner of the compression.

In an embodiment, the processing module is configured to:
split the first feature representation and the second feature representation, to obtain a plurality of sub-feature representations; and
compress each of the plurality of sub-feature representations at the target compression ratio.

In an embodiment, the compression manner of the compression is the compression based on the text encoder; and the processing module is further configured to:
obtain, based on the compressed feature representations, a predicted value of the first text and the prompt by using a text decoder; and
update the text encoder based on the first text, the prompt, and the predicted value.

In an embodiment, the processing module is further configured to:
determine the target compression ratio based on a relationship between a length of the first text and a maximum input text length supported by the large language model.

In an embodiment, the compression manner of the compression is the compression based on the text encoder.

The processing module is configured to:
encode the first feature representation and the second feature representation by using the text encoder, to obtain encoding results; and
use some of the encoding results as the compressed feature representations. The some encoding results are a proportion, equal to the target compression ratio, of encoding results extracted from the encoding results.

In an embodiment, the processing module is configured to:
obtain, based on the compressed feature representations and the second feature representation, the second text by using the large language model.

In an embodiment, the processing module is configured to:
obtain, based on the compressed feature representations and by using the large language model, a feature representation output by a hidden layer of the large language model; and
obtain, based on the feature representation output by the hidden layer, the second text by using the text decoder.

In addition, an embodiment of this application further provides a data processing apparatus. For details, refer to the descriptions of the model inference process in the foregoing embodiment. The apparatus includes:
an obtaining module, configured to obtain a first feature representation and a second feature representation, where the first feature representation is obtained by performing feature extraction on a first text, the second feature representation is obtained by performing feature extraction on a prompt, and the prompt indicates to perform compression at a target compression ratio; and
a processing module, configured to: compress the first feature representation and the second feature representation at the target compression ratio, to obtain compressed feature representations; and
obtain, based on the compressed feature representations, a second text by using a large language model, where the second text is used as a reply text to the first text.

In an embodiment, a compression manner of the compression includes:
an average pooling operation, or compression based on a text encoder.

In an embodiment, the prompt further indicates the compression manner of the compression.

In an embodiment, the processing module is configured to:
split the first feature representation and the second feature representation, to obtain a plurality of sub-feature representations; and
compress each of the plurality of sub-feature representations at the target compression ratio.

In an embodiment, the processing module is further configured to:
determine the target compression ratio based on a relationship between a length of the first text and a maximum input text length supported by the large language model.

In an embodiment, the compression manner of the compression is the compression based on the text encoder.

The processing module is configured to:
encode the first feature representation and the second feature representation by using the text encoder, to obtain encoding results; and
use some of the encoding results as the compressed feature representations. The some encoding results are a proportion, equal to the target compression ratio, of encoding results extracted from the encoding results.

In an embodiment, the processing module is configured to:
obtain, based on the compressed feature representations and the second feature representation, the second text by using the large language model.

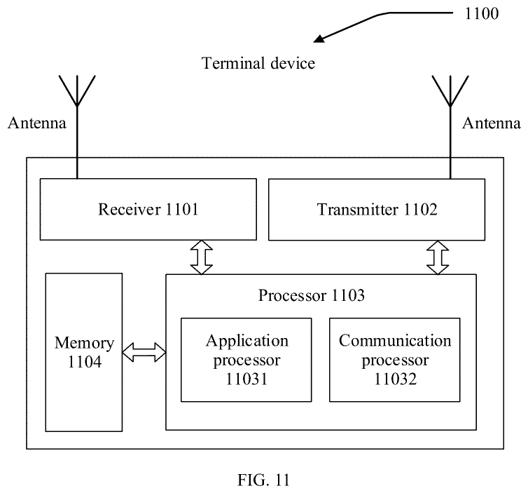

The following describes a terminal device provided in an embodiment of this application. FIG. 11 is a diagram of a structure of a terminal device according to an embodiment of this application. The terminal device 1100 may be represented as a mobile phone, a tablet, a notebook computer, a smart wearable device, or the like. This is not limited herein. The terminal device 1100 may be used as a training device to implement a function of the data processing method in the embodiment corresponding to FIG. 5, or may be used as an execution device to execute a trained model obtained based on the data processing method in the embodiment corresponding to FIG. 5. In an embodiment, the terminal device 1100 includes a receiver 1101, a transmitter 1102, a processor 1103, and a memory 1104 (there may be one or more processors 1103 in the terminal device 1100). The processor 1103 may include an application processor 11031 and a communication processor 11032. In some embodiments of this application, the receiver 1101, the transmitter 1102, the processor 1103, and the memory 1104 may be connected through a bus or in another manner.

The memory 1104 may include a read-only memory and a random access memory, and provide instructions and data to the processor 1103. A part of the memory 1104 may further include a non-volatile random access memory (NVRAM). The memory 1104 stores a processor and operation instructions, an executable module, a data structure, a subset thereof, or an extended set thereof. The operation instructions may include various operation instructions for implementing various operations.

The processor 1103 controls an operation of the execution device. During application, the components of the execution device are coupled together through a bus system. In addition to a data bus, the bus system may further include a power bus, a control bus, a status signal bus, and the like. However, for clear description, various types of buses in the figure are referred to as the bus system.

The methods disclosed in embodiments of this application may be applied to the processor 1103, or implemented by the processor 1103. The processor 1103 may be an integrated circuit chip and has a signal processing capability. In an embodiment, operations in the foregoing method may be implemented by using a hardware integrated logic circuit in the processor 1103, or by using instructions in a form of software. The processor 1103 may be a general-purpose processor, a digital signal processor (DSP), a microprocessor or microcontroller, a vision processing unit (VPU), a tensor processing unit (TPU), and another processor suitable for AI computing, and may further include an application-specific integrated circuit (ASIC), a field-programmable gate array (FPGA) or another programmable logic device, a discrete gate or transistor logic device, or a discrete hardware component. The processor 1103 may implement or perform the methods, operations, and logic block diagrams disclosed in embodiments of this application. The general-purpose processor may be a microprocessor, or the processor may be any conventional processor or the like. The operations in the methods disclosed with reference to embodiments of this application may be directly performed and completed by a hardware decoding processor, or may be performed and completed by using a combination of hardware in the decoding processor and a software module. A software module may be located in a mature storage medium in the art, such as a random access memory, a flash memory, a read-only memory, a programmable read-only memory, an electrically erasable programmable memory, or a register. The storage medium is located in the memory 1104. The processor 1103 reads information in the memory 1104, and completes operation 501 to operation 504 in the foregoing embodiment in combination with hardware of the processor 1103.

The receiver 1101 may be configured to: receive input digital or character information, and generate a signal input related to related settings and function control of the execution device. The transmitter 1102 may be configured to output digital or character information through a first interface. The transmitter 1102 may be further configured to send instructions to a disk group through the first interface, to modify data in the disk group. The transmitter 1102 may further include a display device, for example, a display.

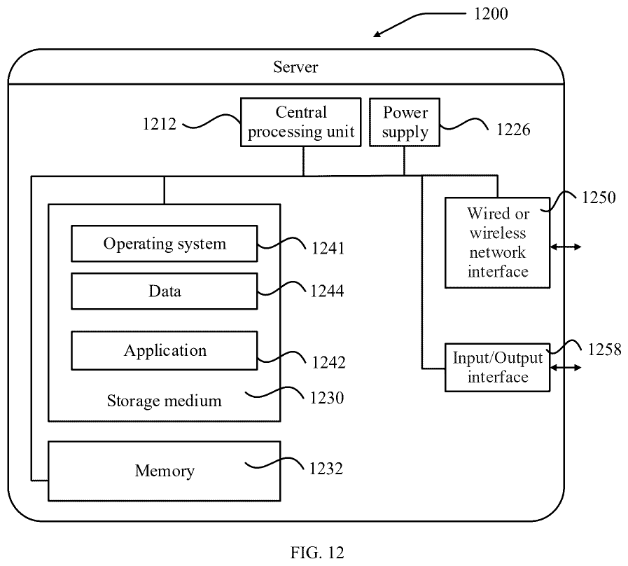

An embodiment of this application further provides a server. FIG. 12 is a diagram of a structure of a server according to an embodiment of this application. In an embodiment, the server 1200 is implemented by one or more servers. The server 1200 may greatly differ due to different configurations or performance, and may include one or more central processing units (CPUs) 1212 (for example, one or more processors) and a memory 1232, one or more storage media 1230 (for example, one or more mass storage devices) that store an application 1242 or data 1244. The memory 1232 and the storage medium 1230 may be transitory storage or persistent storage. A program stored in the storage medium 1230 may include one or more modules (not shown in the figure), and each module may include a series of instruction operations for the training device. Further, the central processing unit 1212 may be configured to: communicate with the storage medium 1230, and perform, on the server 1200, the series of instruction operations in the storage medium 1230.

The server 1200 may further include one or more power supplies 1226, one or more wired or wireless network interfaces 1250, one or more input/output interfaces 1258, or one or more operating systems 1241, for example, Windows Server™, Mac OS X™, Unix™, Linux™, and FreeBSD™.

In an embodiment, the server may be used as a training device to perform operation 501 to operation 504 in the foregoing embodiment, or may be used as an execution device to execute a trained model obtained based on the data processing method in the embodiment corresponding to FIG. 5.

In an embodiment, the terminal device 1100 or the server 1200 may be used as a training device to perform operation 501 to operation 504 in the foregoing embodiment to obtain a trained model, and deploy the trained model on the execution device. Alternatively, the execution device may be in a form of the terminal device 1100 or the server 1200. When the execution device executes the trained model, reference may be made to the model feedforward process in the embodiment corresponding to FIG. 5.

An embodiment of this application further provides a computer program product. When the computer program product is run on a computer, the computer is enabled to perform operations performed by the execution device, or the computer is enabled to perform operations performed by the training device.

An embodiment of this application further provides a computer-readable storage medium. The computer-readable storage medium stores a program used for signal processing, and when the program is run on a computer, the computer is enabled to perform operations performed by the execution device, or the computer is enabled to perform operations performed by the training device.

The execution device, the training device, or the terminal device provided in embodiments of this application may be a chip. The chip includes a processing unit and a communication unit. The processing unit may be, for example, a processor. The communication unit may be, for example, an input/output interface, a pin, or a circuit. The processing unit may execute computer-executable instructions stored in a storage unit, so that a chip in the execution device performs the data processing method described in embodiments, or a chip in the training device performs the data processing method described in embodiments. In an embodiment, the storage unit is a storage unit in the chip, for example, a register or a cache. Alternatively, the storage unit may be a storage unit in a wireless access device but outside the chip, for example, a read-only memory (ROM), another type of static storage device that can store static information and instructions, or a random access memory (RAM).

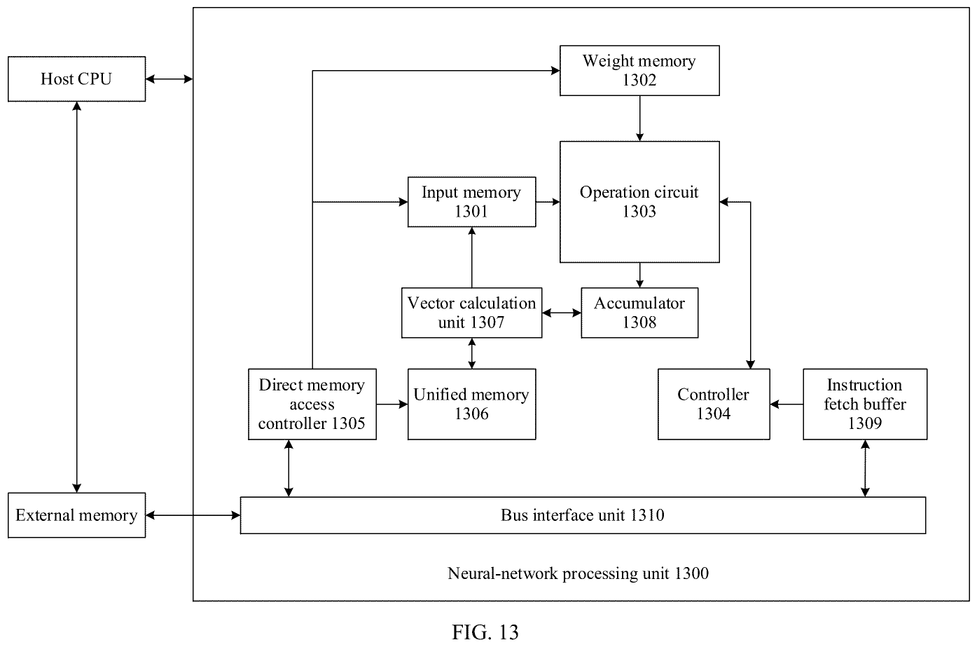

In an embodiment, FIG. 13 is a diagram of a structure of a chip according to an embodiment of this application. The chip may be represented as a neural-network processing unit NPU 1300. The NPU 1300 is mounted to a host CPU (Host CPU) as a coprocessor, and the host CPU allocates a task. A core part of the NPU is an operation circuit 1303. A controller 1304 controls the operation circuit 1303 to extract matrix data in a memory and perform a multiplication operation.

The NPU 1300 may implement, through cooperation between internal components, the data processing method provided in the embodiment described in FIG. 5 and the operations related to the model inference process.

In an embodiment, the operation circuit 1303 in the NPU 1300 includes a plurality of processing units (PE). In an embodiment, the operation circuit 1303 is a two-dimensional systolic array. The operation circuit 1303 may alternatively be a one-dimensional systolic array or another electronic circuit capable of performing mathematical operations such as multiplication and addition. In an embodiment, the operation circuit 1303 is a general-purpose matrix processor.

For example, it is assumed that there is an input matrix A, a weight matrix B, and an output matrix C. The operation circuit fetches, from a weight memory 1302, data corresponding to the matrix B, and caches the data on each PE in the operation circuit. The operation circuit fetches data of the matrix A from an input memory 1301, performs a matrix operation on the data and the matrix B, and stores an obtained partial result or final result of the matrix in an accumulator 1308.

A unified memory 1306 is configured to store input data and output data. Weight data is directly transferred to the weight memory 1302 through a direct memory access controller (DMAC) 1305. The input data is also transferred to the unified memory 1306 by using the DMAC.

A BIU is a bus interface unit, namely, a bus interface unit 1310, and is configured to perform interaction between an AXI bus and the DMAC and between the AXI bus and an instruction fetch buffer (IFB) 1309.

The bus interface unit (BIU for short) 1310 is used by the instruction fetch buffer 1309 to obtain instructions from an external memory, and is further used by the direct memory access controller 1305 to obtain original data of the input matrix A or the weight matrix B from the external memory.

The DMAC is mainly configured to transfer input data in the external memory DDR to the unified memory 1306, transfer the weight data to the weight memory 1302, or transfer input data to the input memory 1301.

A vector calculation unit 1307 includes a plurality of operation processing units. If required, further processing is performed on an output of the operation circuit 1303, for example, vector multiplication, vector addition, an exponential operation, a logarithmic operation, or a value comparison. The vector calculation unit 1307 is mainly configured to perform network calculation, such as batch normalization, pixel-level summation, and upsampling on a feature plane, at a non-convolutional/fully connected layer in a neural network.

In an embodiment, the vector calculation unit 1307 can store a processed output vector in the unified memory 1306. For example, the vector calculation unit 1307 may apply a linear function or a non-linear function to the output of the operation circuit 1303, for example, perform linear interpolation on a feature plane extracted at a convolutional layer. For another example, the vector calculation unit 1307 may apply a linear function or a non-linear function to a vector of an accumulated value, to generate an activation value. In an embodiment, the vector calculation unit 1307 generates a normalized value, a pixel-level summation value, or both a normalized value and a pixel-level summation value. In an embodiment, the processed output vector can be used as an activation input to the operation circuit 1303, for example, used at a subsequent layer in the neural network.

The instruction fetch buffer (instruction fetch buffer) 1309 connected to the controller 1304 is configured to store instructions used by the controller 1304.

The unified memory 1306, the input memory 1301, the weight memory 1302, and the instruction fetch buffer 1309 are all on-chip memories. The external memory is private for a hardware architecture of the NPU.

Any one of the processors mentioned above may be a general-purpose central processing unit, a microprocessor, an ASIC, or one or more integrated circuits for controlling program execution.

In addition, it should be noted that the described apparatus embodiment is merely an example. The units described as separate parts may or may not be physically separate, and parts displayed as units may or may not be physical units, may be located in one position, or may be distributed on a plurality of network units. Some or all of the modules may be selected according to actual needs to achieve the objectives of the solutions of embodiments. In addition, in the accompanying drawings of the apparatus embodiments provided by this application, connection relationships between modules indicate that the modules have communication connections with each other, which may be implemented as one or more communication buses or signal cables.

Based on the description of the foregoing implementations, one of ordinary skilled in the art may clearly understand that this application may be implemented by software in addition to necessary universal hardware, or by dedicated hardware, including an application-specific integrated circuit, a dedicated CPU, a dedicated memory, a dedicated component, and the like. Usually, any function implemented by a computer program can be easily implemented by using corresponding hardware. In addition, hardware structures used to implement a same function may be various, for example, an analog circuit, a digital circuit, or a dedicated circuit. However, as for this application, software program implementation is a better implementation in most cases. Based on such an understanding, the technical solutions of this application essentially or the part contributing to the prior art may be implemented in a form of a software product. The computer software product is stored in a readable storage medium, such as a floppy disk, a USB flash drive, a removable hard disk, a ROM, a RAM, a magnetic disk, or an optical disc of a computer, and includes several instructions for instructing a computer device (which may be a personal computer, a training device, a network device, or the like) to perform the methods in embodiments of this application.

All or some of the foregoing embodiments may be implemented by using software, hardware, firmware, or any combination thereof. When software is used to implement embodiments, the foregoing embodiments may be implemented completely or partially in a form of a computer program product.

The computer program product includes one or more computer instructions. When the computer program instructions are loaded and executed on the computer, the procedures or functions according to embodiments of this application are completely or partially generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, training device, or data center to another website, computer, training device, or data center in a wired (for example, a coaxial cable, an optical fiber, or a digital subscriber line (DSL)) or wireless (for example, infrared, radio, or microwave) manner. The computer-readable storage medium may be any usable medium that can be stored by a computer, or a data storage device, for example, a training device or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like.

1. A data processing method, comprising:
obtaining a first feature representation obtained by performing feature extraction on a first text, and a second feature representation obtained by performing feature extraction on a prompt indicating to perform compression at a target compression ratio;
compressing the first feature representation and the second feature representation at the target compression ratio, to obtain compressed feature representations; and
obtaining, based on the compressed feature representations, a second text by using a large language model, wherein the second text is used as a reply text to the first text.

2. The method according to claim 1, wherein a compression manner of the compression comprises:
an average pooling operation, or compression based on a text encoder.

3. The method according to claim 1, wherein the prompt further indicates a compression manner of the compression.

4. The method according to claim 1, wherein compressing the first feature representation and the second feature representation at the target compression ratio comprises:
splitting the first feature representation and the second feature representation, to obtain a plurality of sub-feature representations; and
compressing each of the plurality of sub-feature representations at the target compression ratio.

5. The method according to claim 1, wherein the method further comprises:
determining the target compression ratio based on a relationship between a length of the first text and a maximum input text length supported by the large language model.

6. The method according to claim 1, wherein a compression manner of the compression is the compression based on the text encoder; and
compressing the first feature representation and the second feature representation at the target compression ratio comprises:
encoding the first feature representation and the second feature representation by using the text encoder, to obtain encoding results; and
using some of the encoding results as the compressed feature representations, wherein the some encoding results are a proportion, equal to the target compression ratio, of encoding results extracted from the encoding results.

7. The method according to claim 1, wherein obtaining the second text by using the large language model comprises:
obtaining, based on the compressed feature representations and the second feature representation, the second text by using the large language model.

8. The method according to claim 1, wherein obtaining, the second text by using the large language model comprises:
obtaining, based on the compressed feature representations and by using the large language model, a feature representation output by a hidden layer of the large language model; and
obtaining, based on the feature representation output by the hidden layer, the second text by using a text decoder.

9. A data processing method, comprising:
obtaining a first feature representation obtained by performing feature extraction on a first text, and a second feature representation obtained by performing feature extraction on a prompt indicating to perform compression at a target compression ratio;
compressing the first feature representation and the second feature representation at the target compression ratio, to obtain compressed feature representations;
obtaining, based on the compressed feature representations, a second text by using a large language model; and
updating the large language model based on the second text and a corresponding ground truth value.

10. The method according to claim 9, wherein a compression manner of the compression comprises:
an average pooling operation, or compression based on a text encoder.

11. The method according to claim 9, wherein a compression manner of the compression is the compression based on the text encoder, and the method further comprises:
obtaining, based on the compressed feature representations, a predicted value of the first text and the prompt by using a text decoder; and
updating the text encoder based on the first text, the prompt, and the predicted value.

12. A data processing apparatus, comprising:
a processor,
a memory coupled with the processor to store instructions, which when executed by the processor, causes the apparatus to:
obtain a first feature representation obtained by performing feature extraction on a first text, and a second feature representation obtained by performing feature extraction on a prompt indicating to perform compression at a target compression ratio;
compress the first feature representation and the second feature representation at the target compression ratio, to obtain compressed feature representations; and
obtain, based on the compressed feature representations, a second text by using a large language model, wherein the second text is used as a reply text to the first text.

13. The apparatus according to claim 12, wherein a compression manner of the compression comprises:
an average pooling operation, or compression based on a text encoder.

14. The apparatus according to claim 12, wherein to compress the first feature representation and the second feature representation at the target compression ratio, the instructions, when executed, further cause the apparatus to:
split the first feature representation and the second feature representation, to obtain a plurality of sub-feature representations; and
compress each of the plurality of sub-feature representations at the target compression ratio.

15. The apparatus according to claim 12, wherein the instructions, when executed, further cause the apparatus to:
determine the target compression ratio based on a relationship between a length of the first text and a maximum input text length supported by the large language model.

16. The apparatus according to claim 12, wherein a compression manner of the compression is the compression based on the text encoder; and
to compress the first feature representation and the second feature representation at the target compression ratio, the instructions, when executed, further cause the apparatus to:
encode the first feature representation and the second feature representation by using the text encoder, to obtain encoding results; and
use some of the encoding results as the compressed feature representations, wherein the some encoding results are a proportion, equal to the target compression ratio, of encoding results extracted from the encoding results.

17. The apparatus according to claim 12, wherein to obtain the second text by using the large language model, the instructions, when executed, further cause the apparatus to:
obtain, based on the compressed feature representations and the second feature representation, the second text by using the large language model.

18. The apparatus according to claim 12, wherein to obtain the second text by using the large language model, the instructions, when executed, further cause the apparatus to:
obtain, based on the compressed feature representations and by using the large language model, a feature representation output by a hidden layer of the large language model; and
obtain, based on the feature representation output by the hidden layer, the second text by using a text decoder.

19. The apparatus according to claim 12, wherein the prompt further indicates a compression manner of the compression.

20. The data processing method according to claim 9, wherein the prompt further indicates a compression manner of the compression.
